(19) United States
(12) Patent Application Publication
(10) Pub. No.: US 2022/0156870 A1
(43) Pub. Date: May 19, 2022

(54) SAFETY PROTECTION SYSTEM FOR PASSENGERS AND DRIVERS OF ONLINE RIDE-HAILING AND TAXI SERVICES

(71) Applicant: Hongming JIANG, Zhejiang (CN)

(72) Inventor: Hongming JIANG, Zhejiang (CN)

(21) Appl. No.: 17/280,767

(22) PCT Filed: Sep. 26, 2019
(86) PCT No.: PCT/CN2019/108283

§ 371 Date: Jan. 31, 2022

(30) Foreign Application Priority Data
Sep. 26, 2018 (CN) 201811125970.9
Nov. 26, 2018 (CN) 201811419941.3

(51) Int. Cl. G06Q 50/30; G06Q 20/32; B60R 22/48; B60Q 5/00; B60Q 1/50; B60R 25/23; B60R 21/12; G08B 21/02

(52) U.S. Cl. CPC G06Q 50/30; G06Q 20/326; B60R 22/48; B60Q 5/001; B60Q 5/005; B60R 2022/4875; B60R 25/23; B60R 21/12; G08B 21/02; B60R 2022/4816; B60Q 1/50

(57) ABSTRACT

A safety protection system for passengers and drivers includes passenger and driver seat belt fastening state detection apparatuses, emergency alarm apparatuses, a car roof sounding alarm, passenger and driver fastening and isolation and protection apparatuses, wherein if a passenger is a single female, a pregnant woman, an elderly man or woman, a child, an infant, a person with difficulty in moving and an intoxicated person, an order will only be assigned to a vehicle provided with the above-mentioned apparatuses

### TECHNICAL FIELD

The invention belongs to personal safety protection of passengers and drivers in the field of traffic.

### BACKGROUND

In recent years, transportation services which book an appointment via the Internet such as Uber and Didi have emerged. Let users not have to wait for a taxi on the street, but pre-book the departure location, departure time, and destination point on the mobile phone in advance. Transportation vehicles for passenger include taxis, tailored taxi, ride sharing, fast ride, buses, etc. The way to carry passengers is that one or more users of a single reservation order ride together. Or all users of multiple scheduled orders carpooling share the cost.

In this article, online taxi booking is abbreviated as online taxi-hailing, and online booking of private passenger car sharing is abbreviated as ride sharing or carpooling.

The current online taxi-hailing, ride sharing and carpooling have fatal safety issues for passengers and drivers.

However, online taxi-hailing and ride sharing have the advantages of being convenient for users to call a car, reducing travel costs for users, alleviating urban traffic congestion, and being green and environmentally friendly. As long as the personal safety protection problem of passengers and drivers can be solved, it is an advanced method than traditional taxis. Traditional taxis is more difficult looking for a car and expensive.

The current taxi-hailing and ride sharing have the following methods for the personal safety protection of passengers and drivers.

1. Strengthen driver background checks. But this method can only reduce the probability of danger for passengers, but not avoid it. In some vicious cases of passenger deaths, the driver's background check not find problem.

2. In the car-hailing application, set a one-key alarm emergency button to upload the driver, vehicle registration data and vehicle location, driving trajectory, passenger information and other data to the police, as well as the emergency contacts of passengers and drivers. But usually the first thing criminals do before committing a crime is to deceive or rob passenger's mobile phones. Passengers are often too late to press the button to call the police. Or press the button to call the police and when the police arrive, something unfortunate has already happened. In previous cases of passenger accidents, the passengers often only had time to shout for help, and even before they could shout for help, the mobile phone had been snatched away. In addition, some companies set up a trip sharing button in the app of the car-hailing software to share their driving route with their emergency contacts.

3. The car has a built-in GPS tracking function to track the trajectory of the vehicle in real time. This method is mostly only useful for pre-prevention and post-event solve a case, but cannot avoid the occurrence of vicious cases.

4. Before the driver accepts the order, the face recognition verification is carried out. This method can only rule out the situation of counterfeiting drivers, or the situation that the driver information does not match, but cannot prevent the driver from committing crimes.

5. During the pickup process, both the driver and the passengers mobile phone were voice recorded during the whole process. This method can only have the effect of providing evidence after the fact, and cannot avoid the occurrence of vicious crimes.

6. Stop providing drivers with privacy such as avatars, gender, age, etc. of passengers, and stop providing drivers with records of where passengers pick up and drop off. These measures can only reduce the driver's purposeful find target passenger in advance, but cannot avoid the occurrence of vicious crimes.

In addition to taxi-hailing, ride sharing, and carpooling, traditional taxis also face the issue of passenger and driver safety. While background checks for taxi drivers are more rigorous than those for taxi-hailing and ride sharing, even though taxis are equipped with GPS and cameras, some taxis also have a isolation net that separates drivers and passengers, but traditional taxis still have a lot of safety issues for passengers and drivers.

Through a set of innovative software and hardware systems, the present invention completely avoids the occurrence of vicious cases of passengers and drivers, and truly and effectively protects the personal safety of passengers and drivers. The safety protection system for passengers and drivers of the present invention can be applied to all traffic travel fields, including but not limited to traditional taxis, buses, short-distance and long-distance buses, private car, taxi-hailing, tailored taxi service, ride sharing, carpooling, online bus booking, etc.

### SUMMARY

A safety protection system for passengers and drivers, comprising a passenger and driver seat belt locking state detection device, a passenger and driver emergency alarm device, a roof sound alarm, a passenger and driver locking device, and a driver and passenger isolation protection device.

When the passenger or driver presses the emergency alarm button, the horn of the roof sound alarm whistle, the display or LED lights display the text message of the alarm, and the lights flash;

From the time of the passenger gets on the car and confirms the order in the taxi app on the mobile phone, to the time of the passenger end the order in the taxi app after the passenger arrives at the destination and alights.

If the detection device of the seat belt lock state detects that the driver has pressed the seat belt lock switch, that is, the driver tries to unfasten the seat belt while the passenger is still in the car,

The safety protection system immediately uses one or more horn, horn in the detection device of the seat belt lock state, horn in the drivers mobile phone, horn in the passenger's mobile phone to sound to alarm at the same time.

The passenger immediately use the car door remote key of the passenger emergency alarm device to open the door, and escape.

At the same time, the safety protection system triggers the roof sound alarm to whistle through horn, the “alarm” text is displayed on the display or LED lights, and the headlights flashes to display the alarm to the surrounding traffic police, police, and passers-by. Or at the same time lock the driver in the drivers seat.

At the same time, the security protection system immediately turns on the camera and microphone of the driver's mobile phone, and call the emergency handling department of the operating company of the taxi service in the safety protection system, conduct video inspections for the scene, upload the video to the security protection system and storage, when necessary, the video is directly connect to the police.

A safety protection system for passengers and drivers, when the driver presses the emergency alarm button, the passenger is locked in the passenger seat; when the passenger presses the emergency alarm button, the driver is locked in the driver's seat.

A safety protection system for passengers and drivers includes isolation protection devices for drivers and passengers; the isolation protection devices for drivers and passengers are detachable structures.

A passenger and driver safety protection system includes passenger silent safety confirmation function.

### BRIEF DESCRIPTION OF THE DRAWINGS

FIG. 1: The method and steps from the passenger submitting the order to the driver taking the order.

FIG. 2: Steps from the driver arrival at the pick-up point to the passenger verification of the driver's information.

FIG. 3: Steps from the driver arrival at the pick-up point, to the passenger testing emergency alarm function, to the passenger get on car.

FIG. 4: Steps from the driver arrival at the pick-up point, to the passenger locking the driver, to the passenger get on car.

FIG. 5: The method and steps from the passenger arrival at the destination point to the dosing of the order.

FIG. 6: Schematic diagram of the Driver Locking Device.

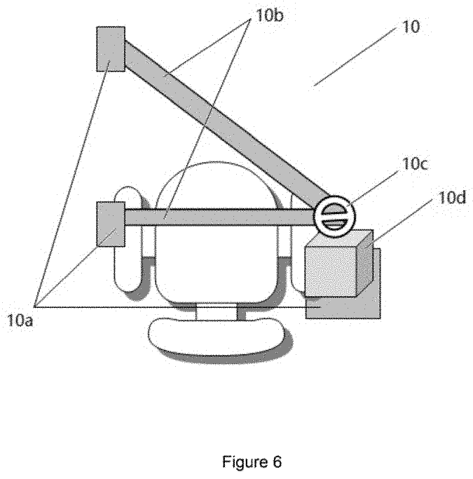

FIG. 7: Schematic of the “L” shaped driver and passenger isolation guards.

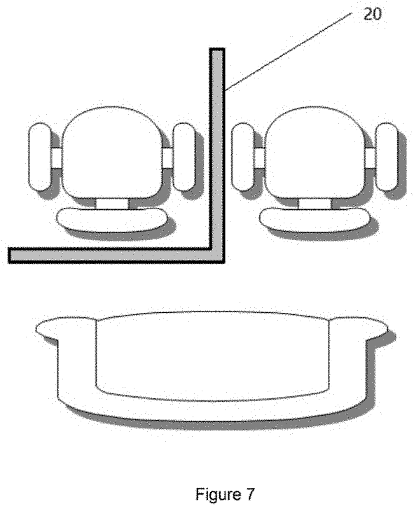

FIG. 8: Schematic of the “cross”-shaped driver and passenger isolation guards.

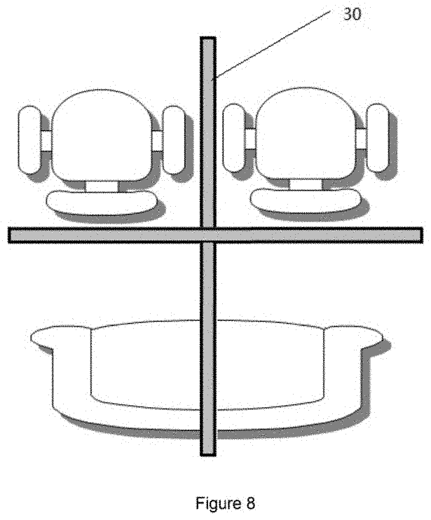

FIG. 9: When a passenger is in the vehicle, if detect the driver attempt to unbuckle the seat belt, triggering the system to alarm.

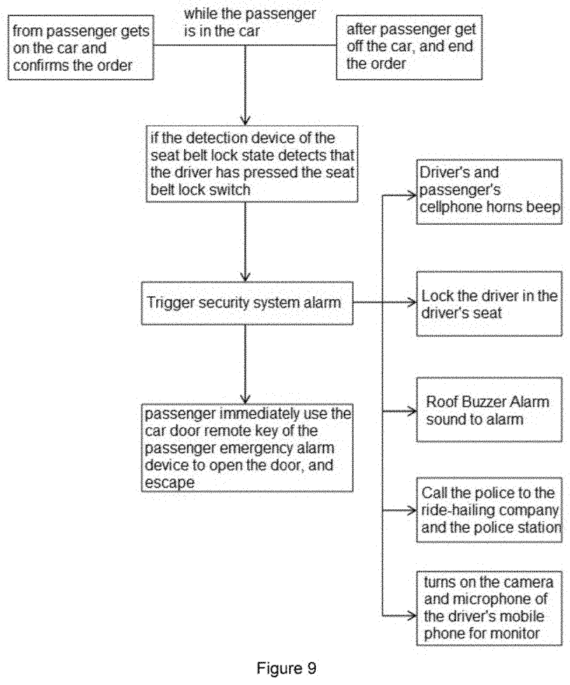

### BRIEF DESCRIPTION OF SYMBOLS

10 Driver Locking Device
10a Fixed parts
10b bondage belt
10c latch
10d Smart Lock
20 “L” shaped isolation guard for driver and passenger.
30 “Cross” shaped isolation guard for driver and passenger.

### DETAILED DESCRIPTION

The present invention provides a safety protection system for passengers and drivers, the system comprises a taxi applications installed in the mobile phones of passengers and drivers provided to passengers and drivers, a cloud software system installed on the server of the operating company which provides taxi services, a cloud software system installed on the server of the operating company which provides taxi services, a device configured in vehicles carrying passengers for detecting the locked state of the car seat belts of passengers and drivers, emergency alarm devices for passengers and drivers, a roof buzzer alarm installed on the car carrying passengers.

Said cell phones of passenger and driver, said car seat belt lock state detection device of passenger and driver, said emergency alarm device of passenger and driver, said roof buzzer, and said server of operating company connect together through the mobile Internet or the Internet network.

The detection device for the car seat belt lock state of the passenger and the driver is arranged in or around the car seat belt buckle of the passenger and the driver; detect whether the car seat belts of passengers and drivers are locked or unlocked use mechanical, electronic, optical, or magnetic methods. The detection device for the car seat belt lock state of the passenger and the driver comprises circuit and horn.

When the safety protection system of the passenger and the driver uses the built-in sensor of the driver's (or passenger) mobile phone to detect that the car is in a non-stationary state, or it is detected that the driving speed of the car is greater than the set value, and the detection device detects that the driver's (or passenger) car seat belt is in an unlocked state at the same time, the safety protection system prompts the driver and passenger through the sound of mobile phones horn of the driver and passenger to fasten the car seat belt.

Of course, another method is to set the sensor in the detection device of the seat belt locking state of the passenger and driver, using the sensors in the detection device, to detect that the car is in a non-stationary state, or it is detected that the driving speed of the car is greater than the set value, and the detection device detects that the driver's (or passenger) car seat belt is in an unlocked state at the same time, the safety protection system prompts the driver and passenger through the sound of mobile phones horn of the driver and passenger to fasten the car seat belt.

The built-in sensor of the driver's (or passenger's) mobile phone, and the sensor in the detection device of the seat belt locking state, including but not limited to speed sensor, acceleration sensor, displacement sensor, vibration sensor, three-axis gyroscope, Sound sensor, temperature sensor, location sensor (GPS), collision sensor, smoke sensor, etc.

The emergency alarm device includes an emergency alarm device for passengers and an emergency alarm device for drivers.

The passenger emergency alarm device includes a car door remote key part, a roof buzzer remote control part, and a horn part. The car door remote control key part includes a car door remote control circuit, a battery, and a casing, and at least is equipped with a car door unlocking remote control button, and can also be equipped with a car door locking remote control button.

The car door remote control key part in the passenger emergency alarm device can be used as the car remote control key itself, and the passenger emergency alarm device is connected through a leather case or structure, combined the car remote control key and the roof buzzer alarm remote control part, main circuit part, horn part, and other parts together.

The passenger emergency alarm device also includes a main circuit part, and the main circuit includes a CPU module, a storage module, a control circuit module, a GPS module, a short-range wireless communication module, a detection circuit module, and an LED light.

The passenger emergency alarm device is provided with a roof buzzer test button. When the passenger presses the roof buzzer test button, the roof buzzer LED light will light up once (for example, the green light will be on) and the horn will beep at the same time to verify the passenger emergency alarm device can normally remotely control the roof chirping alarm.

The driver's mobile phone and the short-distance wireless communication module in the passenger emergency alarm device are connected through short-distance wireless connection. The short-range wireless communication module is a wireless communication technology, including Bluetooth, or WiFi, or ultrasound, usually Bluetooth.

When the short-range wireless connection signal between the driver's mobile phone and the passenger emergency alarm device is detected to be disconnected, or when the signal value is less than the set value, the horn of the driver's mobile phone and the horn of the passenger's emergency alarm device both buzzed to warn. This feature prevents passengers from deliberately taking the passenger emergency alarm device away, or forgetting to return it to the driver after arriving at the destination. It can also prevent the driver from losing the car remote control key at ordinary times, because the passenger emergency alarm device actually has a built-in car remote control key.

The driver's mobile phone can uses the GPS chip of the passenger emergency alarm device to find the location of the passenger emergency alarm device. This feature can help drivers retrieve lost car key.

The driver emergency alarm device includes a remote control part of a roof buzzer alarm and a horn part;

The remote control part of the roof buzzer alarm of the passenger or driver includes a remote control circuit of the roof buzzer alarm, a battery, and a casing, and is equipped with an emergency alarm button for the passenger or driver.

The roof buzzer alarm is set on the roof of the car, The roof buzzer alarm includes circuits, horns, displays or LED lights, headlights and lampshades.

From the time of the passenger gets on the car and confirms the order in the taxi app on the mobile phone, to the time of the passenger end the order in the taxi app after the passenger arrives at the destination and alights.

If the detection device of the seat belt lock state detects that the driver has pressed the seat belt lock switch, that is, the driver tries to unfasten the seat belt while the passenger is still in the car.

The safety protection system immediately uses one or more horn, horn in the detection device of the seat belt lock state, horn in the driver's mobile phone, horn in the passenger's mobile phone to sound to alarm at the same time.

The passenger immediately use the car door remote key of the passenger emergency alarm device to open the door, and escape.

At the same time, the security protection system immediately turns on the camera and microphone of the driver's mobile phone, and call the emergency handling department of the operating company of the taxi service in the safety protection system, conduct video inspections for the scene, upload the video to the security protection system and storage, when necessary, the video is directly connect to the police.

The passenger emergency alarm device is arranged behind the rear seat, or on the platform behind the rear seat, or on the door wall of the rear car door, or in a place that cannot be touched by other drivers. The passenger emergency alarm device is hand-held, placed in the passenger's hand, and is equipped with a loop belt, which can be put on the passenger's finger or wrist.

The driver's emergency alarm device is arranged on the seat handle, or on the side of the seat belt buckle, or on the steering wheel of the car, or on the control panel of the car, or on the door wall of the door on the driver's side, or Set it in a place that other passengers cannot reach.

When the passenger or the driver presses the emergency alarm button, the horn of the roof chirping alarm will sound the alarm, and the display will display the text information of the alarm, danger, car accident, help and call the police. When the passenger presses the emergency alarm button, it is equivalent to pressing the car door unlock button at the same time, and the car door is open.

The roof chirping alarm can also be used as a display of the car's order status when the passenger or driver does not press the emergency alarm button. For example, when there is no order, it will display “empty car”, when there is a carpool order, it will display “carpool”, and when the order has been received, it will display “someone”. The above-mentioned specific display text can be custom.

The safety protection system for passengers and drivers of the present invention further comprises a driver locking device, which locks and fixes the driver on the driver's seat so that the driver cannot leave the driver's seat.

The Driver Lock Device includes a fixing part, a bondage part, and a smart lock. The Driver Locking Device, the mobile phone of the passenger and the driver, the detection device of the seat belt locking state of the passenger and the driver, the emergency alarm device of the passenger and the driver, the roof buzzer, and the server of the operating company are connected through the mobile Internet or the Internet.

The fixed part fixes the driver locking device on the driver's seat, or on the roof of the car, or on the chassis of the car, or on other solid and immovable parts of the car, or the fixed place is a combination of the above.

The bondage belt component includes at least one bondage strap, which may be one, or two, or three or more.

The bondage position of the strap is from the driver's shoulder to the driver's waist, or around the driver's waist, chest, or legs, or a combination of the above;

The binding belt is a traditional driver's seat belt material, or cut-resistant material, further, the anti-cutting material is metal, alloy, fiber, glass fiber, or a combination of the above;

The smart lock on the locking device is remote wireless control, which is remote wirelessly controlled by the algorithm of the safety protection system for passengers and drivers of the present invention.

From the time of the passenger gets on the car and confirms the order in the taxi app on the mobile phone, to the time of the passenger end of the order in the taxi app after the passenger arrives at the destination and alights.

If the detection device of the seat belt lock state detects that the driver has pressed the seat belt lock switch, that is, the driver tries to unfasten the seat belt while the passenger is still in the car. One of the options of the safety protection system of the present invention is to immediately activates the smart lock of the driver locking device to lock the driver in the driver's seat for a set time. The second option of the safety protection system of the present invention is to activate the driver smart lock and the passenger smart lock at the same time, lock the driver on the driver's seat for a set time, and lock the passenger on the passenger seat for a set time.

The driver locking device of the present invention can also be remotely controlled by the passenger to control the smart lock of the driver locking device through the terminal taxi application program in his mobile phone to perform remote control locking and unlocking. The cloud software system on the server of the taxi operating company remotely controls the locking and unlocking of the smart lock on the driver locking device through the Internet and mobile Internet. The driver can send a request to unlock the smart lock on the driver locking device to the cloud software system on the taxi operating company's server through the terminal taxi application in his mobile phone.

The smart lock on the locking device includes the main board, CPU chip, memory chip, mobile communication chip, GPS chip, battery, control part, lock cylinder, bolt, lock catch, lock latch, indicator light, microphone, speaker, shell and other components. Smart locks can also include speed sensors, acceleration sensors, displacement sensors, vibration sensors, three-axis gyroscopes, sound sensors, temperature sensors, location sensors (GPS), collision sensors, smoke sensors and other sensors one or more of the devices.

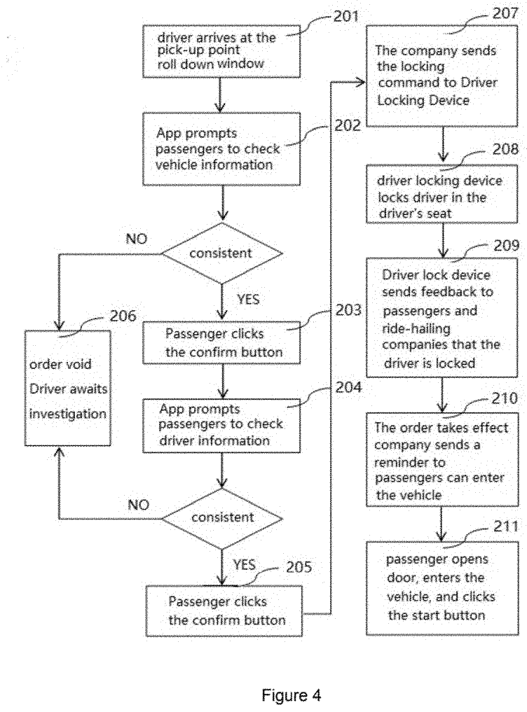

FIG. 4 is an example of a Driver Locking Device. In FIG. 4, 10 is a Driver Locking Device, 10a is a fixing part. 10b is a bondage belt. 10c is a latch, and 10d is a smart lock.

The driver locking device of the present invention installed in the car carrying passengers, can be separate and independent from the traditional driver seat belt. The driver has to wear both a conventional seat belt and is also locked by the driver's locking device. The driver has to wear both of traditional car seat belt and is also locked by the driver locking device. The driver locking device of the present invention can also directly replace the traditional car seat belt, and the driver only needs to fasten the bondage belt of the driver locking device, Or the fixing parts and bondage belt of the driver locking device of the present invention are the same as the traditional car seat belt, only the smart lock replace the mechanical locks of the traditional seat belts.

The driver locking device of the present invention has two kinds of locking. One is the buckle of the traditional car seat belt, which has the same structure and the same function. The buckle is buckled by the driver himself, and the driver can release the buckle by pressing the ordinary release button.

The other locking is the locking of the smart lock. The locking and unlocking of the smart lock is controlled by the safety protection system or the passenger remotely. Usually, the driver cannot unlock the smart lock by himself. The smart lock can only be unlocked by going through the set steps.

There are two methods for passengers to lock and unlock the driver, the first method is for passengers to use the taxi application in their mobile phones to directly send instructions of lock and unlock to the driver locking device; the second method is for passengers to send a request to lock or unlock the driver to the cloud software system on the taxi operating company's server; the cloud software system of the taxi-hailing company sends a lock or unlock instructions to the smart lock of the driver locking device, remotely control the lock and unlock of the driver locking device through the mobile Internet.

The following examples are all the second method. The second method is a more secure method. Of course, it is also within the protection scope of the present invention that the passenger directly sends the locking and unlocking instructions to the driver locking device. The first method is less expensive, slightly less secure, and less protected for the driver. Because of the first method, it is possible for hackers who are not passengers to crack the smart lock and illegally lock the driver. There is also the possibility that the driver illegally cracks the smart lock and unlocks it without authorization.

The safety protection system for passengers and drivers of the present invention can also include isolation protection devices for drivers and passengers. The driver and passenger isolation guards are detachable structures that can be quickly dismantled and installed. The driver and passenger isolation guards are any single material or combination materials, such as metal, alloy, glass, bulletproof glass, fiberglass, or a combination of metal and glass. The top of the driver and passenger isolation protection device is fixed to the top of the vehicle, the bottom is fixed on the vehicle chassis or seat, the left and right sides are fixed to the frame, the front and back are fixed on the dashboard and the rear seat of the car seat

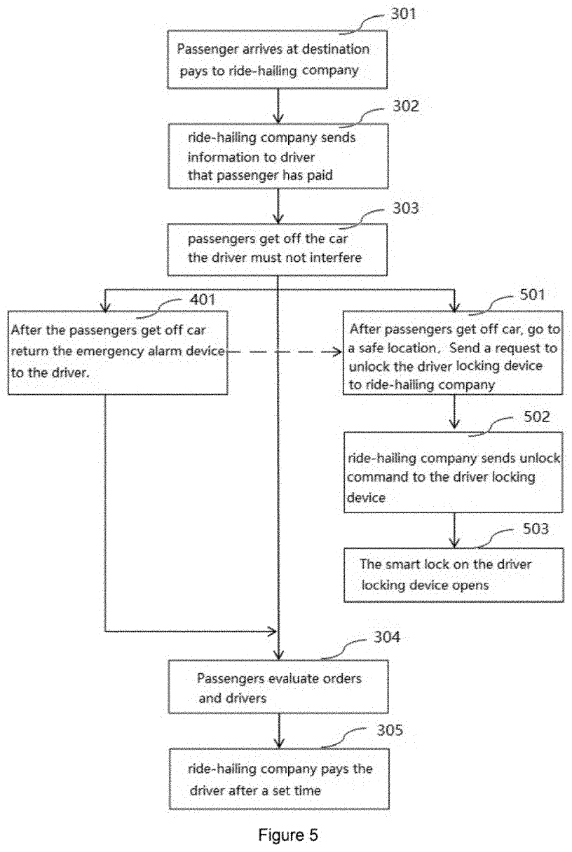

The driver and passenger isolation protection device is an “L” shape to isolate the driver separately, and all other passengers share a space, as example of 20 in FIG. 5. Or is the “cross” shape to isolate the interior of the car into four separate spaces, the driver and each passenger are in a separate isolated space, as example of 30 in FIG. 56. When the “cross”-shaped isolation guards for the driver and the passenger are in the rear seats, the shape of the lower edge of the isolation guards fits the shape of the seats of the rear seats.

When the ride-hailing company allocates passenger orders, only vehicles equipped with a cross-shaped driver and passenger isolation protection device will allocate the carpool order to its driver. Vehicles that are not equipped with a “cross”-shaped driver and passenger isolation protection device are not allowed to accept carpool orders, and are not allowed to carry passengers who do not know each other at the same time. This more fully guarantees the safety of passengers, and avoids contradiction, conflicts, or injuries between passengers who do not know each other.

The safety protection system for passengers and drivers of the present invention provides a terminal car-hailing application program installed in the mobile phones of passengers and drivers for use by passengers and drivers.

The car-hailing application contains various reminding interfaces and warning interfaces for passenger and driver safety. The safety protection system for passengers and drivers of the present invention provides a cloud software system installed on the server of an taxi service operating company. The cloud software system includes various processes and steps of analyzing orders, broadcasting orders, confirming orders and monitoring orders in the whole process.

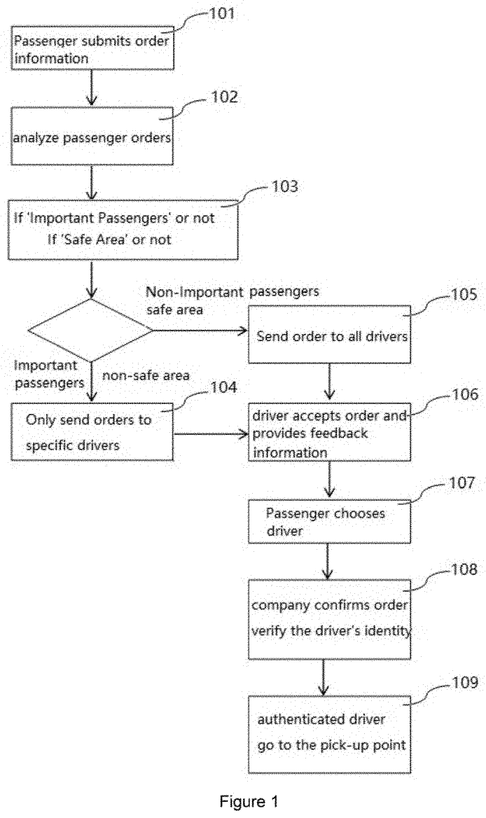

As shown in FIG. 1, in step 101, the passenger submits the order information to the taxi operating company. The order information includes the departure location, that is, the driver's pick-up point, departure time, destination point, number of passengers, gender and age of each passenger, and whether to accept a ride-sharing. The taxi-hailing company automatically records the time when the user submits the order. In step 101, the passenger generally clicks on the map to select the departure point and the destination point. On the interface of submitting the order, there will be options for departure time, such as immediate departure, departure in 5 minutes, departure in 10 minutes, departure in half an hour, etc, or passengers can directly enter the specific departure time. If the passenger has not registered his user information, the user will be prompted to complete the registration.

When registering, users need to complete real-name registration, including their real name, real phone number, ID number, gender, age, and upload the latest avatar. The taxi operating company conducts real-name verification of the passenger's registration information. The verification methods include image verification, such as taking a photo of the passenger holding the ID card, and video verification, such as taking a video with the passenger holding the ID card. The ride-hailing company verifies the gender and age of the passenger's ID number submitted by the passenger. Every time a passenger submits an order, the ride-hailing company verifies the passenger's information, such as requiring the passenger to take a photo and keep it, or requiring the passenger to perform facial recognition verification. On the interface for submitting the order, it includes asking passengers to fill in whether the trip is alone and whether there are passengers accompanying them. If the passenger chooses that this trip is the passenger alone, the order will go to the next interface. If the passenger chooses to include other passengers in this trip, an interface will appear asking the passenger to fill in the information of other passengers on the trip together, such as how many people in total, the gender and age of each person, and if necessary, please provide the photos of other passengers.

In step 101, on the interface for submitting the order, the option of whether the passenger accepts the carpooling is also included. If the passenger chooses to accept the carpooling for this trip, it may be cheaper than the price of the alone trip. If the passenger chooses not accept carpooling this trip, once a driver accepts this order, the taxi operating company will temporarily stop the driver's order-taking function in the terminal taxi app on the driver's phone until the driver completes the order. If the driver privately pulls another passenger except the passenger who does not accept carpooling, once the report of the passenger who does not accept carpooling is submitted, 1s the driver will be fined immediately, the order will be stopped, and his account will be suspend, and other penalties.

In step 101, on the interface for submitting the order, if the passenger chooses to accept carpooling for this trip, the taxi operating company will give priority to allocating the order to the vehicle equipped with the “cross”-shaped driver and passenger isolation protection device.

The taxi operating company divides all drivers and vehicles into two categories. Vehicles with “cross”-shaped driver and passenger isolation protection devices are classified as one category, named “carpooling vehicles”.

Vehicles that are not equipped with “cross”-shaped driver and passenger isolation protection devices are another category, named “non-ride sharing vehicles”. Only “carpooling vehicles” can accept ride-sharing orders from passengers. “non-ride sharing vehicles” cannot accept ride-sharing orders from passengers.

As shown in FIG. 1, in step 102, the taxi operating company analyzes the orders submitted by the passengers. Analyze when passengers submit their orders, submitted departure locations, submitted destination points, submitted departure times, the number of submitted passengers, and the gender and age of each passenger. In step 101, on the interface for submitting the order, a prompt interface is also included to prompt whether there is a passenger who is inconvenient to move among, and whether there is a person who has been drinking. The ride-hailing company analyzes passenger orders, based on the summary of all order information submitted by all passengers at each time, and the summary of all driver and vehicle information waiting for ordersat each time, two big data information, plus the order allocation algorithm, real-time Make the allocation of each order.

As shown in step 103 in FIG. 1, the taxi-hailing company broadcast orders to different drivers, after analyzing the order information submitted by the passengers, base on the information of whether the passengers are single women, pregnant women, the elderly, children, infants, people with mobility impairments, people who have drunk, and whether they accept carpool.

“Important passengers” include single women, pregnant women, the elderly, children, babies, people with limited mobility, and people who have drunk alcohol, if the passenger is an “Important passenger”, Ride-hailing companies automatically mark such orders as “Important passenger orders”, and give a higher level of security protection.

Passengers who are not belong to “Important passengers” are “Non-important passengers”, ride-hailing companies automatically mark such orders as “Non-Important passenger orders”.

The ride-hailing company divides all drivers and vehicles into two categories, drivers and vehicles of the first category can only pick up “Non-Important passenger orders”. That is, such drivers and vehicles can not pick up single women, pregnant women, the elderly, children, infants, people with limited mobility, and people who have drunk alcohol.

Another category of drivers and vehicles can pick up all types of passengers, both “Non-Important passengers orders” and “Important passengers orders” can be picked up;

As shown in step 105 in FIG. 1, only when the passengers do not include single women, pregnant women, the elderly, children, infants, people with limited mobility, and people who have drunk alcohol, the ride-hailing company will broadcast the order to all drivers and vehicles.

As shown in step 104 in FIG. 1, if the passengers include single women, pregnant women, the elderly, children, infants, people with limited mobility, people who have drunk alcohol and other “key passengers”, the ride-hailing company will only broadcast this order to specific drivers and vehicles that meet specific requirements.

Only vehicles with seat belt locking status detection device, emergency alarm device and roof chirping alarm can accept orders of “Important passengers”. Or on this basis, a vehicle with a driver locking device can accept orders of “Important passengers”. Or on this basis, vehicles with isolation protection devices for drivers and passengers can accept orders of “Important passengers”.

In addition, the safety protection system of the present invention can also be set up as a female driver, regardless of whether the vehicle is equipped with a seat belt locking state detection device, an emergency alarm device, a roof chirping alarm, and a driver locking device, she can accept orders of “Important passengers”. The above categories are specific drivers who meet specific requirements.

As shown in step 102 in FIG. 1, the Ride-hailing companies analyze orders submitted by passengers. Analyze when passengers submit their orders, submitted departure locations, submitted destination points, submitted departure times, the number of submitted passengers, and the gender and age of each passenger.

Taxi operating companies divide the geographic area of the earth into different geographic security levels according to population density, degree of safety, public security situation, and the time required for police to arrive.

Different types of drivers and vehicles can only accept orders with different geographic security levels, geographical security level includes “safe area” and “non-safe area”. For example, set the geographic extent of the city center as a “safe area”. Geographical areas that are not within the safe area of the city center are referred to as “non-safe area”. Although some places are located in the city center, the law and order are poor, and the geographical areas with high crime rate are also classified as “non-safe areas”. Once a passenger's departure point, destination point, or travel route exceeds the urban area, including suburban areas, it is set as a “dangerous area”, which is a type of “non-safe area”.

Once a passenger's departure point, destination point, or itinerary is in “non-safety area”, no matter whether the passenger who submits the order is “Important passengers”, only the vehicles with belt lock state detection device, emergency alarm device, and roof buzzer alarm can accept the order of “non-safe areas”. Or on this basis, the vehicle with the driver locking device can accept the order of “non-safe areas”. Only vehicles with driver and passenger isolation guards on this basis can accept orders for “dangerous areas”. In order to protect the safety of female drivers, no matter what the vehicle settings, female drivers can only take orders in the “safe area” and cannot take orders in the “non-safe area”.

As shown in step 105 in FIG. 1, only orders that entire trips is in the “safe area” will broadcast to all drivers. Combining what was said above, only Non-Important passengers orders broadcast to all drivers. So only orders that are “Non-Important passengers” and the entire trip is in “safe area” are broadcast to all drivers.

As shown in step 104 in FIG. 1, if trip is in an “non-safe area”, regardless of whether the passenger is an “Important passengers”, this order will only be broadcast to specific drivers and vehicles that meet specific requirements. As can be seen from the description of “Important passengers” above, if passenger is an “Important passengers”, regardless of whether the trip is in a “non-safe area”, this order will only be broadcast to specific drivers and vehicles that meet specific requirements.

If the passenger is both an “Important passenger” and the itinerary is out of the “safe area”, or the time is “non-safe time”, the ride-hailing company will mark the order as a “high-risk order” and provide the highest level of safety protection; the highest level of security protection includes full video surveillance, dedicated customer service, direct police video connection, and dedicated escort. Only vehicles with driver locking device, driver and passenger isolation guards can accept “high-risk orders”.

The time range of the itinerary of an order similar to the geographic range of the order, is also divided into “safe time” and “non-safe time”; “Non-safe time” includes “dangerous time”. For example, set 8:00 am to 8:00 pm as “safe time”, and set 11:00 pm to 5:00 am as “dangerous time”. The system broadcast range of orders, and the conditions of the vehicle and driver taking the order, for “safe time”, “non-safe time” and “dangerous time”, are equivalent to “safe area”, “non-safe area”, “dangerous area”.

As shown in step 104 and step 105 in FIG. 1, when broadcasting the passenger's order to the driver, hide the passenger's user name, gender, age and other privacy.

In the past, a few taxi-hailing companies publicity taxi-hailing and ride sharing has social function, and disclosed the information of passengers, especially the age, avatar of the female passenger, and other drivers' evaluation of the female passenger's appearance and body to all drivers. It causes a large number of sexual hunting, seduction and even rape, killing and other things that hurt female passengers. The current practice of taxi companies is to hide the passengers gender, age, avatar and other information, and only disclose the passengers user name. However, the driver can still guess whether the other party is male or female through the passenger's user, and thus select female passengers.

The terminal taxi application program installed in the mobile phone of the passenger and the driver provided for the passenger and the driver, assign a random fixed-format string to each passengers order. The string does not have any gender characteristics, and the driver cannot guess whether the passenger is male or female from the string. Another embodiment of the present invention is to allocate a fixed character string in a fixed format to each passenger, and each order of the passenger uses the fixed character string in the fixed format. The cost of this method is slightly cheaper. However, there is a potential loophole, that is, the driver can learn whether a certain fixed string corresponds to a male or a female by repeatedly pulling the passenger by himself or by communicating with other drivers. Each passengers order is assigned a random, fixed-format string, so the driver has no chance of guessing in advance whether the passenger is male or female.

A random fixed-format string assigned to each passenger's order, the format can be year-month-day-time-city-serial number-is it a safe area-is it a safe time-is it an important passenger.

For example, 201809241005-0571-0018-01-01-01, the meaning represented by this example is the 18th passenger who placed an order in Hangzhou at 10:05 on Sep. 24, 2018. The order travels in the city center, at safe time, The passenger is important passenger. For further passenger privacy, the last two figures representing whether the passenger is an important passenger can be hidden when shown to the driver.

In this way, the information of each passenger that the driver sees is just a string of numbers, and the gender of the passenger cannot be known.

The terminal taxi application program installed in the mobile phone of the passenger and the driver provided for the passenger and the driver, contains text chat and voice calls function for passengers and drivers. When the passenger and the driver conduct text chats and voice calls, the driver displays the real driver's avatar, the user name is the driver's real name, and the vehicle's license plate number and other information. Passengers do not display avatars, and the user name is a fixed-format string that is randomly assigned each time. In this way, even if the same driver and the same passenger meet in different purchase order, the displayed user name of the passenger will be different each time. And every time the passenger and the driver choose to end the order, and there is no dispute or complaint, the chat record between the driver and the passenger will be deleted in the terminal taxi application of the passenger and the driver, and the chat record will no longer be retained. The cloud software system of the taxi operating company may be retained for a period of time before being deleted, so that it can be verified when there are complaints and feedback.

As shown in step 104 and step 105 in FIG. 1, when broadcasting the passengers order to the driver, only the user name of a random string of the passenger is displayed, how many passengers are there, where is the departure point, when is the departure time, where is the destination point, and whether the carpooling is accepted. Or only display the user name of a random string of passengers, how many passengers are there, where is the departure point, when is the departure time, and whether the carpooling is accepted; no destination point information is displayed, only the approximate distance of the entire trip is displayed.

As shown in step 104 and step 105 in FIG. 1, The taxi operating company preferentially broadcasts the passengers order to drivers who meet the requirements of steps 104 and 105, who are close to the passengers departure point and who are not taking orders; and preferentially broadcast the passengers order to drivers with high passenger ratings.

As shown in step 106 in FIG. 1, the driver who received the broadcast of the passenger order and is willing to accept this order, the driver clicks the “Get Order” button in the taxi application on his mobile phone, or “Accept” button; the taxi-hailing company will feed back the information of all drivers who have clicked the “Get Order” button to the passengers who submitted the order.

Passengers will receive feedback information of all drivers who accept the order; the driver's feedback information includes: the driver's real name, female drivers can choose to display their nicknames, real avatar of the driver, female drivers can choose to display a virtual avatar, driver's age, female driver does not show age, driver height and weight (female driver does not show), exterior photo of the vehicle, whether the vehicle is equipped with Seat belt locking status detection device, emergency alarm devices, roof buzzer alarms, whether the vehicle is equipped with a driver locking device, whether the vehicle is equipped with isolation and protection devices for the driver and passengers, vehicle model, vehicle license plate number, vehicle age, whether the driver has passed the background check, whether the driver holds a qualification certificate, whether the vehicle meets the requirements of relevant departments, the average of all passenger ratings, number of complaints from passengers, quotation for this order of the driver;

As shown in step 107 in FIG. 1, passengers can choose which driver to ride by viewing the feedback of all drivers who have taken the order, as well as their quotations for this order.

when the passenger selects the driver and vehicle for this order, the information of selected driver and vehicle are sent to the taxi-hailing company, as shown in step 108 in FIG. 1. The ride-hailing company confirms the order and authenticates the driver selected by the passenger. Identity verification includes face recognition, or fingerprint recognition, or iris recognition, or voice recognition, or a combination of the above several types of identity verification.

At the same time, the taxi-hailing company informed other drivers who accept for this order that they did not succeed in get this order;

When the driver first registers with the taxi operating company, he must go through real-name authentication, background check, check for criminal history, check for traffic violation, driving age, total mileage, whether it complies with the “Taxi”. Qualification Management Regulations for Automobile Drivers or relevant industry norms and professional norms of various countries and regions, whether they hold relevant qualification certificates, and whether the vehicle meets the requirements of relevant departments, such as axle distance, model, vehicle age, etc.

And whether the vehicle is equipped with a seat belt locking state detection device, an emergency alarm device, a roof buzzer alarm, a driver locking device, and whether the vehicle is equipped with an isolation protection device for the driver and passengers.

Only these drivers and vehicles that meet the requirements can register as drivers on the platform of the ride-hailing company. The registration information of drivers and vehicles is regularly updated and reviewed at regular intervals.

Next, as shown in step 109 in FIG. 1, the driver who passes the identity verification departs to the pick-up point, which is the departure point submitted by the passenger in the local order.

The passenger and driver safety protection system of the present invention provides the terminal taxi application program, contains a reminder interface to remind passengers whether have drunk alcohol, and a test interface to test the passenger's sobriety level. In the reminder interface for reminding passengers whether drink alcohol, the passengers are prompted to input whether they have drunk alcohol. If the passenger chooses have not drink alcohol, the terminal taxi app displays a warning message: “if the passenger lies, all the responsibility lies with the passenger.” If the passenger chooses have drink alcohol, the terminal taxi application will display a test interface to test the passenger's sobriety level. The test interface includes logical cognition test questions, response sensitivity test questions, visual clarity test questions, hearing clarity test questions, and passenger video recordings. Only passengers who have passed the passenger sobriety test interface are allowed to submit orders. Passengers who fail the test are reminded to contact emergency contacts to pick him up. The taxi operating company immediately add passengers who fail the passenger sobriety test interface to the high-risk list for key monitoring. If the passenger who fails the passenger sobriety test interface test, still insists on taking a taxi alone, the terminal taxi application will display the exemption interface. Remind users to insist on taking taxis when they are not awake. The passengers themselves are responsible for accidents, and the taxi operating company is not responsible.

Taxi-hailing companies can also display a test interface for testing passengers' sobriety according to the time when passengers submit their orders. As long as it is later than the time set by the system, regardless of whether the passenger drinks or not, the test interface for testing the passenger's sobriety is displayed. For example, after 11 p.m., regardless of whether the passenger drinks or not, the test interface for testing the passenger's sobriety is displayed.

If the taxi operating company detects that a single woman submits an order later than a certain system-set time, the order will be listed as a high-risk order, and the whole process will be monitored. For example, after 11 p.m., a single woman submits a taxi order, and the order is listed as a high-risk order, and the drivers mobile phone is monitored by video throughout the process.

The ride-hailing companies provide special night service vehicles, which are owned by the ride-hailing companies themselves or rented by themselves. The drivers recruited and reviewed by the taxi operating company are specially work for the orders of single women, pregnant women, children and other key passengers at night. The dedicated drivers are preferably women, and each person wears a camera device on the chest, similar to a Law Enforcement Recorder, and the whole process is recorded. Night service vehicles are equipped with isolation protection devices for drivers and passengers, and are equipped with multiple cameras to record the interior of the vehicle throughout the process. Such specialized drivers and vehicles are more expensive than ordinary drivers and vehicles, but they can ensure the safety of single women at night, and can also obtain huge business profits through more expensive prices. That is to say, in this case, as shown in step 104 in FIG. 1, the rule is changed, the order is not broadcast to any driver, and the order is directly taken by special professional vehicles and professional drivers operated by the taxi operating company itself, without steps of 106, 107, 108, and 109.

The terminal taxi application includes a reminder interface to remind passengers of the remaining battery power of the mobile phone. The taxi operating company calculates the approximate time required for the entire trip based on the departure and destination points submitted by the user. And remind passengers if the remaining battery power of the mobile phone cannot last for the required time of the trip, please bring a mobile phone charging device (such as a power bank) or cancel the order and change the ride time.

Or, the taxi operating company reads the remaining battery information of the passenger's mobile phone through the terminal taxi application, and calculates whether the remaining battery of the passengers mobile phone can support the time required for the entire trip. If it cannot be supported, remind the passenger to bring a mobile phone charging device, or remind the passenger to cancel the order and change the ride time.

The terminal taxi application includes a test to detect the driver's fatigue, and a test to detect the driver's sobriety level. The test of driver's fatigue and sobriety includes video connection check, including the driver's total driving time and total mileage in one day, including the number of consecutive order days, including sobriety test questions.

The above description, based on the example of FIG. 1, describes each step of the present invention from the passenger submitting the order information to the driver taking the order.

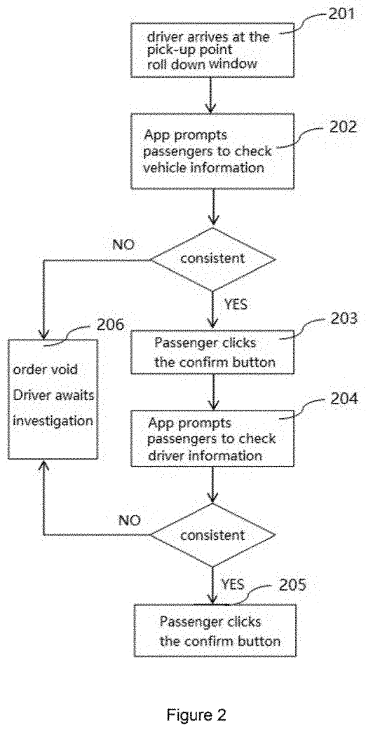

Next, as shown in step 201 in FIG. 2, after the driver takes the order, he arrives at the pick-up point, which is the departure point where the passenger submits the order. The safety protection system for the passenger and the driver of the present invention stipulates that after the driver arrives at the pick-up location, the car window must be rolled down, so that the passenger can see the driver clearly. After receiving the order, the driver arrives at the pick-up location, rolls down the window, in the taxi-hailing application provided to the driver which installed in the driver mobile phone, click “Arrive at the pick-up location” to notify passengers and ride-hailing companies.

Next, as shown in step 202 in FIG. 2, when the driver arrives at the pick-up location and finds that the gender and number of passengers are inconsistent with the gender and number of passengers in the submitted order information, the driver can choose to cancel the order immediately.

The prompt interface of the terminal taxi app reminding passengers to check the vehicle information, showing the appearance photo of the vehicle, whether the vehicle is equipped with a seat belt locking state detection device, an emergency alarm device, a roof buzzer alarm, a driver locking device, and whether the vehicle is installed There are isolation protection devices for the driver and passengers, the model of the vehicle, the license plate number of the vehicle and other information, which are provided to the passengers for verification. After the passenger has checked the above vehicle information one by one, click “Confirm” or “Comply”. As shown in step 203 in FIG. 2, the current order goes to the next step 204.

Passengers check the above vehicle information one by one. If there is any inconsistency, click “Inconformity”. Then the current order goes to step 206, the current order is invalid, and the driver's account is immediately suspended for investigation.

As shown in step 204 in FIG. 2, after the vehicle information is checked and confirmed by the passenger, the terminal taxi application in the passenger's mobile phone displays a prompt interface reminding the passenger to check the driver's information. Only when the passenger clicks “Confirm” or “Compliant” in the prompt interface of this driver information verification, the order can proceed to the next step, otherwise the order will be invalid, and the driver's account will be suspended immediately for investigation.

The prompt interface of the terminal taxi app reminds the passenger to check the driver's information, and displays the driver's clear facial photo, as well as the driver's full body photo, the driver's height and weight, the driver's age and other driver information for confirmation to the passenger. Of course, the female driver may not display the above driver information. For confirmation items such as the driver's height and weight, and the driver's age, passengers only need to confirm roughly, no precise confirmation is required.

The full body photo of the driver can be provided at one time, or the taxi operating company requires the driver to take a photo of the clothes he is wearing today before work every day and upload it to the taxi operating company, and ask the driver to re-take a photo and upload it if he changes his clothes on the same day.

Passengers check the above driver information one by one, and if there is any inconsistency, click “inconformity”. Then the current order goes to step 206, the current order is invalid, and the driver's account is immediately suspended for investigation.

Passengers check the above driver information one by one and click “Confirm” or “Comply” after they are all correct. As shown in step 205 in FIG. 2, this order enters the next step. If the passenger chooses a vehicle that is not equipped with any seat belt locking status detection device, emergency alarm device, roof chime alarm, driver locking device, and isolation protection device for driver and passenger; the same as the traditional taxi steps, Get on the bus and click the order start button, and click the end order button after reaching the destination.

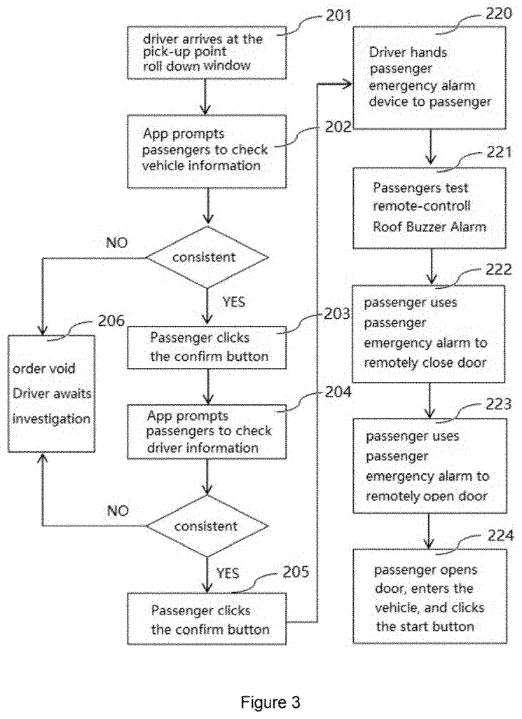

If the passenger selects a vehicle equipped with a seat belt locking state detection device, an emergency alarm device, and a roof chirping alarm, the process proceeds to step 220, as shown in FIG. 3. After the passenger verified the driver's information, he still stood outside the car and did not get into the car immediately. The driver handed the passenger emergency alarm device to the passenger through the window.

Next, in step 221, the passenger presses the test button of the roof chirping alarm to test whether the remote control function of the roof chirping alarm is normal. If the passenger sees the LED light of the roof buzzer on and hears a beep (or a few beeps) of the roof buzzer, it means that the remote control function of the roof buzzer is normal, then go to the next step. If the remote control function of the test roof buzzer alarm is not normal, give up entering the car, and the taxi order will be void. The driver takes the passenger emergency alarm device or the roof chime alarm to repairs.

Next, as in step 222, the passenger presses the car door lock remote control button on the passenger emergency alarm device. If the passenger hears a beeping sound on the car door and cannot open the car door by pulling the door handle, it means that the car door closing remote control function is normal, then enter the next step.

Next, in step 223, the passenger presses the car door unlocking remote control button on the passenger emergency alarm device. If the passenger hears a beep on the car door and pulls the door handle, the car door can be opened, which means that the car door opening remote control function is normal, then enter next step.

Next, as in step 224, the passenger opens the door, enters the vehicle, clicks the order start button in the taxi software, and the operating company sends the navigation route to the driver, and the order officially takes effect.

If in steps 222 and 223, the passenger test vehicle door opening or closing remote control function is not normal, then give up to enter the car, the taxi order is invalid. Driver takes passenger emergency alarm device to repair.

As shown in step 102 in FIG. 1, the ride-hailing companies divide orders into two categories, bases on the information of the driver's gender, age, height and weight in this order, bases on the information of the number of passengers, bases on the gender and age of each passenger, bases on the information of the departure place, departure time, destination point of the order, bases on the information of whether the order is allow other passengers to ride together. One type is the order that needs to lock the vehicle driver, and the other type is the order that does not need to lock the vehicle driver.

The types of orders that do not need to lock the driver include: the driver is female, regardless of whether the passenger is male or female; when the driver is male and the passengers are all male. The specific setting conditions that do not need to lock the driver can be set arbitrarily, and the above setting conditions are just examples.

The types of orders that need to lock the driver include: the driver is a male and the passenger is a female; or the driver is male and all passengers are female. The specific setting conditions that need to be locked for the driver can be set arbitrarily, and the above setting conditions are just examples. For example, when the driver is male, the passenger is a female, and the itinerary is “non-safe area” or “non-safe time”, it is classified as an order type that needs to lock the driver.

For the order type that needs to lock the driver, before the driver submits accept order, the taxi operator will detect the power of the smart lock of the driver's locking device of the driver's vehicle. If the battery of the smart lock is low, the driver cannot accept the order that needs to lock the driver. And remind the driver to charge the smart lock until it is fully charged before allowing the driver to accept orders that require the driver to be locked.

When the taxi operating company classifies this order as an order that does not require the driver to be locked, after the passenger verifies that the vehicle information and driver information are correct in step 205 in FIG. 2, the terminal taxi application in the passenger's mobile phone sends the prompt interface that can get on the bus is given to passengers. After the passenger gets on the bus, the taxi operating company sends the route navigation map of the order to the terminal taxi application in the driver's mobile phone. This order has officially entered into force, and it has entered the transport driving.

When the taxi operating company classifies this order as an order that needs to lock the driver, the passenger cannot get on the bus immediately after verifying that the vehicle information and driver information are correct in step 205 in FIG. 4. The terminal taxi app in the passenger's mobile phone will have a clear prompt interface prompting the passenger not to get on the bus temporarily. And there is a prompt interface that prompts passengers to send a request to lock the driver, and the passenger clicks on the prompt interface to send a request to lock the driver.

As shown in step 207 in FIG. 4, after receiving the request to lock the driver sent by the passenger, the cloud software system of the taxi operating company remotely sends a locking instruction to the driver locking device on the passenger vehicle. The next step is step 208 in FIG. 4, after receiving the locking instruction from the cloud software system of the taxi operating company, the driver locking device locks the driver on the driver's seat. Next, as shown in step 209 in FIG. 4, the driver locking device sends feedback information that the driver has been locked in the drivers seat to the passenger and the taxi operating company. The driver locking device sends feedback information that the driver has been locked to the cloud software system of the taxi operating company through the mobile communication chip on the smart lock. The smart lock on the driver's locking device has an indicator light, and a speaker. When the driver's locking device locks the driver, the speaker emits a distinct sound for the passenger to hear, and the indicator light illuminates for the passenger to see.

When the cloud software system of the taxi operating company receives the feedback information from the driver's locking device that the driver has been locked in the driver's seat, as shown in step 210 in FIG. 4. The taxi operating company sends a prompt interface for entering the vehicle to the taxi terminal application in the passenger's mobile phone, and reminds the passenger on the prompt interface to verify the sound feedback of the speaker of the smart lock on the driver's locking device, and light feedback of the indicator light on the smart lock. When the passenger confirms that the feedback from the speaker and indicator light of the smart lock is correct, as shown in step 211 in FIG. 4, the passenger opens the door and enters the vehicle. Click the prompt interface and prompt button of “I have entered the vehicle, start the journey” in the terminal taxi application in the passenger's mobile phone. After the cloud software system of the taxi operating company receives the feedback that the passenger has entered the vehicle, the cloud software system of the operating company sends the navigation route of the order to the driver's terminal taxi application. After all the above steps, the passenger's order officially enters the driving stage.

The passenger and driver safety protection system of the present invention provides a terminal taxi application program installed in the passenger's mobile phone for use by the passenger, and includes the passenger's silent safety confirmation function. The passenger silent security confirmation feature consists of the passenger setting a security code. In the terminal taxi application, a confirmation interface for confirming the safety of the passenger will pop up at every set time while the passenger is on the vehicle, and the passenger will enter the set password to unlock the safety confirmation interface. The silent security confirmation function can be confirmed by the user's face recognition in addition to the users input password. Once the feedback from the passengers on the safety confirmation interface exceeds the set time, the alarm system will be triggered immediately, without the need for the passengers to manually press a button to alarm. Triggered alarm systems are one or more simultaneous alarms of the driver's mobile phone alarm, the passengers mobile phone alarm, the roof alarm whistle, the taxi service operating company's alarm platform, and the police alarm platform.

When the vehicle is driving, passengers will be reminded by the silent security confirmation function from time to time. When the passenger enters a password that only he knows, it can prove that the passenger has always been safe.

The passenger silent safety confirmation function is very helpful for the safety of passengers who are not sober after drinking, fall asleep after drinking, or fall asleep due to fatigue, and it is a good way to prevent passengers from being drugged.

When the passenger reaches the destination point, as shown in step 301 in FIG. 5, the passenger first pays the cost of the order to the taxi operating company in the terminal taxi application in the mobile phone. The next step is step 302 in FIG. 5, the taxi operating company sends feedback information to the driver after receiving the payment from the passenger. The next step is step 303 in FIG. 5, the passenger gets off the bus. At this time, the driver has received the notification information that the passenger has paid from the taxi operating company, and the driver must not interfere with the passenger getting off the bus.

If the vehicle is not equipped with a seat belt locking state detection device, an emergency alarm device, a roof chirping alarm, and a driver locking device, go directly to step 304, the passenger evaluates the order and the driver, and the order is completed. Next, step 305 is entered, and the taxi operating company pays the driver for this order after the set time.

If the vehicle is equipped with a seat belt locking state detection device, an emergency alarm device, and a roof chirping alarm, after step 303, go to step 401, after the passenger gets off the vehicle, the passenger emergency alarm device is returned to the driver through the window. After step 401, step 304 is entered, the passenger evaluates the order and the driver, and the order is completed. Next, step 305 is entered, and the taxi operating company pays the driver for this order after the set time.

If the vehicle is equipped with a driver locking device, after step 303, the driver is still locked on the driver's seat by the driver locking device. The next step is step 501 in FIG. 5. After the passenger gets off the car and closes the door, or after the passenger gets off the car and walks to a safe position, that is, after walking for a while, has a safe distance from the vehicle just now, or the passenger has already walked to a crowded location or a safe and secure location, send a request to the ride-hailing company to unlock the driver locking device. If the passenger forgets to send a request to unlock the driver to the taxi operating company after getting off the bus, the taxi operating company will send the passenger a prompt interface to the driver to unlock after the set time after the passenger pays. The next step is step 502 in FIG. 5, when the taxi operating company receives the passenger's request for unlocking the driver, the taxi operating company remotely sends an unlocking instruction to the driver locking device on the passenger vehicle. The next step is step 503 in FIG. 5, when the driver's locking device on the passenger vehicle receives the unlock command remotely sent by the taxi operating company, the smart lock of the driver's locking device is unlocked. The next step is step 304 in FIG. 5, the passenger evaluates the order and driver. The next step is as shown in step 305 in FIG. 5, after the set time, the taxi operating company pays the cost of the order to the driver.

If the vehicle is equipped with a seat belt locking state detection device, an emergency alarm device, a roof buzzer alarm, and a driver's locking device, after step 303, go to step 401, and after step 401, go to step 501.

The current ride-hailing companies, such as Uber and Didi's one-click alarm, or the whole process of recording, cannot prevent rape, and murder from happening at all. When the driver has a motive for committing the crime, as long as he grabs the passenger's mobile phone, turns it off or throws it out of the window, the passenger will not have time to call the police. The passengers were locked inside the vehicle by the driver, unable to resist. The first crime scene in many rape cases is the back seat of a vehicle.

The safety protection system for passengers and drivers of the present invention completely ensures the safety of passengers and drivers, and completely prevents the occurrence of rape, and murder and other cases. First, for female drivers, in the passenger and driver safety protection system of the present invention, the taxi operating company only allocates orders for female passengers to female drivers, but does not allocate orders for male passengers.

Secondly, as long as the female passenger rides in the vehicle of the male driver, before the female passenger enters the vehicle, the male driver has been locked in the drivers seat by the drivers locking device. The steps and procedures of the safety protection system for the passenger and the driver of the present invention ensure that the female passenger must check that the information of the driver and the vehicle is correct; ensured that the female passenger must have received the audible feedback and indicator light feedback from the smart lock of the drivers locking device; ensured that the female passenger will only enter the vehicle after receiving the information that the taxi operator has reported that the driver has been locked. Before the female passenger entered the vehicle, the male driver had been locked in the drivers seat and could not move. Naturally, the male driver could not do any harm to the female passenger. The binding strap of the driver locking device of the present invention is made of anti-cutting material, and it is impossible for the driver to cut or cut the binding strap. The male driver himself was unable to open the smart lock on the driver locking device.

After the female passenger got off the bus and walked to a safe position, she sent an unlock request to the taxi operator, that is, the driver was locked in the drivers seat until the female passenger got off the bus and reached a safe position. Therefore, the invented safety protection system for passengers and drivers ensures the personal safety of female passengers when riding in the vehicle of a male driver.

According to the above description, it can be known that the driver's locking device installed in the car carrying passengers ensures the safety of the female passenger when riding in the vehicle of the male driver. Unless the driver holds a gun at the female passengers head and threatens the female passenger to press the end order and unlock the drivers locking device, other situations are 100% guaranteed for the safety of the female passenger.

Because the male driver was locked before the female passenger got on the bus until after the female passenger got off the bus.

However, the drivers locking device may put the driver's personal safety at risk. In order to make himself safer, the most thorough way for the driver is to install the isolation protection device between the driver and the passenger. At the same time, the driver's locking device is installed, as well as the driver and passenger isolation protection device, so that both the passenger and the driver are 100% safe. For passengers, the driver is locked in the driver's seat from before boarding to after getting off, and there are isolation guard between driver and passenger, and the driver cannot threaten passengers with guns or knives. The “L”-shaped isolation guard for driver and passenger protect the safety between driver and passenger. The “cross”-shaped driver and passenger isolation protection device not only protects the safety between the driver and the passenger, but also protects the safety of different passengers. With the isolation protection device for the driver and the passenger, during the journey, the passenger cannot physically attack the driver due to the isolation protection device for the driver and the passenger. Even if the passenger arrives at the destination or gets off the bus halfway, as long as the driver locks the driver door, the passenger cannot open the driver's door to touch the driver, and the driver can drive the car away at any time, throwing away the passengers with bad intentions.

Another example of the present invention is that the driver's vehicle is only equipped with a barrier between the driver and the passenger, and no driver's locking device is installed. This situation guarantees the safety of the driver, but not the safety of the passengers. Because the driver can locks the passenger in the car first, and then open the door from the outside to grab the passenger.

The safest and safest way is to install both the driver lock device, and the driver and passenger isolation guards. If only one of these two devices is installed, the driver's locking device is installed first, because the cost of the driver's locking device is much lower than that of the driver and passenger isolation protection device. And the priority of passenger safety is higher than the priority of driver safety.

In addition, the safety protection system for the passenger and the driver of the present invention does not allow the passenger and the driver to settle the order fee privately. When all passengers submit order information, the terminal taxi application in the passenger's mobile phone will have a clear warning interface, warning the passenger not to trade privately with the driver.

In addition, in the passenger and driver safety protection system of the present invention, after receiving the passenger's order payment, the taxi operating company does not immediately pay the order payment to the driver, but only pays the driver after a set period of time. During this set time, if the passenger has any complaints, it will affect the driver's order revenue. This further urges the driver to serve the passengers well during the entire process of picking up and carrying passengers. In the safety protection system for the passenger and the driver of the present invention, the passenger starts to evaluate the order and the driver after getting off the bus and walking to a safe position. It is avoided that the previous evaluation is affected by the driver, even the driver himself took the passenger's mobile phone for evaluation, and the driver threatened the passenger to give a good evaluation.

In the past, taxi-hailing companies made transportation service products into social products. In terms of advertising and product design, they allowed or even encouraged communication between drivers and passengers.

Drivers could see photos of female passengers and other drivers' comments about the female passenger. Appearance and figure evaluation, and can actively choose female passengers. This has resulted in a lot of sexual harassment, as well as bad things such as sex dating that hurt the feelings and bodies of female passengers.

The safety protection system for the passenger and the driver of the present invention includes the function of preventing chatting and verbal sexual harassment between the driver and the passenger. When the passenger gets on the bus, the terminal taxi application in the driver and passenger's mobile phone automatically starts recording the whole journey. Or in order to protect the privacy of passengers, only the driver's mobile phone is recorded during the whole process, and the passenger's mobile phone is not recorded. All drivers will receive the content push of the terminal taxi app's regulations that do not allow accost and verbal sexual harassment of passengers. And clearly inform the driver that if he picks up a conversation and verbally sexually harasses the passenger, he will be fined, as well as suspend the account, close the account, and transfer it to the police. All passengers will receive a content push from the terminal taxi app that can report drivers for chatting up and verbally sexually harassing passengers. If the driver picks up a conversation or verbally harassed the passenger, the passenger can report it in the terminal taxi app. Different types of pick-up conversation or verbal sexual harassment correspond to different levels of fines for the driver, as well as account suspension, account closure, transfer to the police and other penalties.

For example, if the driver asks the passenger for personal information, such as whether he is a student, what job he does, where he is, and other personal information, and the passenger clicks to report, the driver will be fined 20% of the cost of the order. If the driver asks the passenger whether he is married, whether he has a boyfriend or other emotional information, and the passenger clicks to report, the driver will be fined 40% of the cost of the order. If the driver's speech contains sexual content, or the driver asks for the passenger's contact information, or the driver asks the passenger to meet, the passenger clicks to report, the driver will be fined 60% of the cost of the order, and the driver's account will be suspended for three days. If the driver expressly or impliedly wants to have sex with the passenger, and the passenger clicks to report, the driver will be fined 100% of the cost of the order, and the driver's account will be suspended for one month. In serious cases, the case will be handed over to the police. Because the whole process is recorded, as long as the passenger reports, the taxi operating company will transfer the recording to verify, and once the passenger's report is verified, the driver will be punished immediately. As shown in step 305 in FIG. 5, after the passenger pays the taxi operating company, the money is temporarily placed in the taxi operating company's account, and is not immediately paid to the driver. Instead, the driver is paid after a set period of time. During this set period of time, as long as the passenger reports a report, the taxi operating company will immediately call the recording for verification and deduct the money from the driver, and return the deducted money to the passenger. If the driver is dissatisfied with the passenger's report, he can make a complaint to the taxi operating company, and the taxi operating company will verify it according to the recording. Of course, if the female passenger has a good impression of the male driver, and the female passenger takes the initiative to approach the male driver, it is allowed but not encouraged. In this case, the male driver in turn asks the female passenger about some situations. If the female passenger report, the male driver can representations base on recording. That is to say, female passengers are allowed to take the initiative to strike up a conversation with a male driver, but male drivers are absolutely not allowed to take the initiative to strike up a conversation with a female passenger. Male passengers are also not allowed to take the initiative to strike up a conversation with the female driver, otherwise the female driver can report the male passenger, and the taxi operating company can impose a fine on the male passenger, suspend the male passengers taxi account, block the male passengers taxi account, call the police, and other punishment.

In the safety protection system for passengers and drivers of the present invention, if the vehicle is not equipped with isolation protection devices for drivers and passengers, the vehicle cannot accept orders for carpooling orders, which will affect the order volume and income of drivers. If the vehicle is equipped with isolation protection devices for the driver and passengers, the vehicle can undertake the order of the carpooling order. The total value of carpooling orders is usually higher than the total value of non-carpooling orders, and the drivers order volume and income will increase.

Therefore, a vehicle with isolation protection devices for drivers and passengers will greatly increase the income of the driver, and the input cost of installing isolation protection devices for drivers and passengers in the drivers vehicle will bring more orders, and more income per order, and generate a high return on investment.

The safety protection system for passengers and drivers of the present invention also includes a business model in which the taxi operating company lends the driver to purchase and install a seat belt locking state detection device, an emergency alarm device, a roof buzzer, a driver locking device, and isolation protection device for driver and passenger. The principal and interest of the loan is then repaid by the driver through the revenue of each subsequent order. The specific repayment method can be that all the income of the driver for each order is used to repay until the principal and interest are fully paid; or a percentage of the income of each order that the driver receives is used to repay until the principal and interest are repaid. Because in all the orders for taxis, the orders of female passengers and the orders of male passengers are almost 50%, or the orders of female passengers are a little more accounted for 60%. Among all drivers, male drivers account for the vast majority. Therefore, the safety protection system for passengers and drivers of the present invention will preferentially allocate the orders of female passengers to those equipped with seat belt locking status detection device, emergency alarm device, roof buzzer alarm, driver locking device, driver and passenger isolation protection devices; the carpooling orders will only be allocated to vehicles with isolation protection devices for drivers and passengers, and the price of these orders is higher than that without driver locking devices and isolation protection device for drivers and passengers.

Therefore, in this business model, important passengers, passengers whose routes are beyond the city center, carpooling passengers, and passengers who take taxis at night, pay a little high price for each order and obtain safety guarantee. Drivers get loans and pay off their loans quickly and earn more profits with more orders and higher prices per order. Taxi-hailing companies not only solve the world problem of passenger and driver safety, but also can enter all markets in all countries in the world, instead of being rectified, sealed up and banned by governments of various countries because of the vicious safety cases of passengers. Ride-hailing companies also earn good interest income through loans.

Since the driver locking device of the passenger and driver safety protection system of the present invention has a strong restraining effect on the freedom of movement of the driver, there are some measures to protect the driver. First, only in the order type that needs to lock the driver, the passenger is allowed to lock the driver, and in the order type that does not require the driver to be locked, the passenger is not allowed to lock the driver.

Secondly, when the driver reaches the pick-up point and finds that the gender and number of passengers are inconsistent with the gender and number of passengers on the submitted order information, the driver can immediately cancel the order.

In the passenger and driver safety protection system of the present invention, a plurality of driver locking devices can also be installed in the passenger vehicle, one of which is used for the passenger to lock and unlock the driver. The other one or more are used by the driver to lock and unlock a passenger, or multiple passengers.

The same device can have different names. For example, if the locking device of the present invention is used to lock the driver, it is called “driver locking device”. If the locking device of the present invention is used to lock a passenger, it is called a “passenger locking device”.

When the driver locks and unlocks the passenger, it is also the driver who sends the request to lock and unlock the passenger to the cloud software system on the server of the taxi operating company, and the cloud software system of the taxi operating company sends the locking or unlocking instructions. For the smart lock on the passenger locking device, remotely control the locking and unlocking of the passenger locking device through the mobile Internet. The passenger also has a passenger emergency unlock button (also the passenger emergency alarm button above), which can unlock the “passenger locking device”. In addition, the passenger's emergency unlock button is also the car's door-opening remote control button. When the passenger presses the passenger's emergency unlock button, the rear door of the car is opened, and the smart lock on the passenger is opened. At the same time, the roof buzzer on the roof sends out a buzzer warning signal. When the passenger or driver presses the emergency unlock button (panic alarm button), the ride-hailing company will conduct video verification of the driver and passenger in real time.

In the safety protection system for the passenger and the driver of the present invention, when there are multiple locking devices, the passenger must first lock the driver, and then the driver can lock the passenger. It must also be that the driver unlocks the passenger first, and then the passenger unlocks the driver. Alternatively, the passenger can send an unlocking request to the passengers own locking device, and after the passenger unlocks and gets off the car, performs the unlocking the driver operation.

Multiple locking devices can replace the driver and passenger isolation protection devices to some extent, and play a protective role for the driver.

Ideal for situations where the driver is a male and the passengers are multiple males. Or the route of the trip is outside the safe area of the city, especially when the route is very desolate.

The drivers emergency alarm button, which can also be the drivers emergency unlock button, is usually set on the smart lock of the drivers locking device.

The drivers emergency unlock button is also a car door remote control button, and the car doors remote control circuit is arranged below the drivers emergency unlock button. When the driver presses the emergency unlock button of the driver, it is equivalent to pressing the remote control button of the car door at the same time, and the front door next to the driver and the two rear doors of the car are simultaneously opened at the same time. In this way, even in extreme situations such as a car accident, the driver can unlock the smart lock by himself and escape. And the driver locking device of the present invention makes the driver safer. First of all, because there is a driver locking device that locks the driver in the drivers seat, the driver will drive more stable and less impatiently than normal, and pay more attention to driving safety than driving speed, this in itself reduces the chance of a car accident. In addition, in the case of a car accident, there is a buzzer on the roof, which also makes the traffic police, policemen, and passers-by nearby come to help immediately after hearing the alarm sound and the alarm display information. Compared with the traditional car accident without the roof honking alarm, the driver can get more and timely assistance.

In addition, in the passenger and driver safety protection system of the present invention, when the passenger and the driver press the emergency alarm button, or the driver emergency unlock button or the passenger emergency unlock button, send the vehicle information, vehicle location information, driver information, passenger information, etc to the cloud software system of the taxi operating company. Or it can be sent to the police at the same time as it is sent to the ride-hailing company's cloud-based software system. The cloud software system of the taxi operating company can turn on the camera and microphone on the drivers or passenger's mobile phone when the passenger and driver press the emergency alarm button, or the driver's emergency unlocking button or the passengers emergency unlocking button to conduct video inspection and video on the scene, verification, and audio and video recording.

Not in the case of a car accident, when the passenger forgets to send a request to unlock the driver, and the passenger's mobile phone is out of power or turned off. The terminal taxi application installed in the driver's mobile phone used by the driver also has an “emergency unlock request” button. The driver presses the “emergency unlock request” and sends it to the cloud software system of the taxi operating company. The taxi operating company will use the camera and microphone on the drivers mobile phone to verity whether the rear door of the car has been opened. Only if the rear door is opened at the same time and no one is checked in all places in the car, the smart lock on the drivers locking device can be remotely unlocked.

The passenger emergency alarm device of the present invention, if is not mobile or hand-held, but is fixed somewhere inside the vehicle. Then the driver does not need to hand it to the passenger through the window before the passenger gets in the car, but after the passenger gets in the car, the test of the remote control opening and closing the door and the test of the remote control roof sounding alarm are carried out. Passenger get off the car directly after arriving at their destination, without returning the passenger emergency alarm device to the driver like a hand-held type.

The specific layout and operation mode made according to the idea of the present invention are all within the protection scope of the present invention. The replacement and displacement of the positions, numbers, types, etc in the specific examples of the present invention are all within the protection scope of the present invention. Changes to specific sizes, shapes and materials in the present invention are all within the protection scope of the present invention.

For example, replace or shift the position, number, type, etc of the driver locking device, and the driver and passenger isolation and protection device. For example, changes in the size, shape, and material of the fixing components in the driver's locking device, as well as changes in the fixing place. For example, changes to the size, shape and material of the binding strap in the driver locking device, no matter what material the binding strap is made of, all fall within the protection scope of the present invention. For example, changes the size, shape, and material of the driver and passenger isolation and protection device, and no matter what material the driver and passenger isolation guards are made of, it is within the scope of the present invention.

For example, replace and shift the position, quantity, type, etc of the components on the smart lock. Whether one or more components are added to the components included in the smart lock described of this article, or one or more components are reduced, it is a common technical means in the technical field and falls within the protection scope of the present invention.

Those of ordinary skill in the art can understand that the above are only preferred embodiments of the present invention, and are not intended to limit the present invention.

Although the present invention has been described in detail with reference to the foregoing embodiments, for those skilled in the art, It is still possible to modify the technical solutions described in the foregoing embodiments, or perform equivalent replacements to some of the technical features. Any modification, equivalent replacement, improvement, etc. made within the spirit and principle of the present invention shall be included within the protection scope of the present invention.

For example, deleting or adding a specific one or several steps in the methods and steps in the embodiments of the present invention, and changing the order of a specific one or several steps, are all within the protection scope of the present invention.

1: A safety protection system for passengers and drivers, comprising:
the system comprises taxi applications installed in the mobile phones of passengers and drivers provided to passengers and drivers,
a cloud software system installed on the server of the operating company which provides taxi services,
a device configured in vehicles carrying passengers for detecting the locked state of the car seat belts of passengers and drivers an ‘Emergency Alarm Device’ for passengers and drivers,
a ‘Roof Buzzer Alarm’ installed on the car carrying passengers;
said mobile phones of passenger and driver, said ‘Car Seat Belt Lock State Detection Device’ of passenger and driver, said ‘Emergency Alarm Device’ of passenger and driver, said ‘Roof Buzzer Alarm’, and said server of operating company connect together through the mobile Internet or the Internet network;
the detection device for the car seat belt lock state of the passenger and the driver is arranged in or around the car seat belt buckle of the passenger and the driver,
detect whether the car seat belts of passengers and drivers are locked or unlocked use mechanical, electronic, optical, or magnetic methods
the detection device for the car seat belt lock state of the passenger and the driver comprises circuit and horn;
wherein when the safety protection system of the passenger and the driver uses the built-in sensor of the driver's (or passenger's) mobile phone to detect that the car is in an non-stationary state, or it is detected that the driving speed of the car is greater than a set value, and the detection device detects that the driver's (or passenger's) car seat belt is in an unlocked state at the same time,
the safety protection system prompts the driver and passenger through the sound of mobile phones horn of the driver and passenger to fasten the car seat belt;
the ‘Emergency Alarm Device’ includes an emergency alarm device for passengers and an emergency alarm device for drivers;
the passenger emergency alarm device includes a car door remote key part, a roof buzzer remote control part, and a horn part,
the car door remote control key part is equipped with a car door unlock remote control button and a car door lock remote control button;
the passenger emergency alarm device also includes a main circuit part, and the main circuit includes a CPU module, a storage module, a control circuit module, a GPS module, a short-range wireless communication module, a detection circuit module, and a LED light;
the passenger emergency alarm device is hand-held, placed in the passenger's hand, and is equipped with a loop belt, which can be put on the passenger's finger or wrist;
the passenger emergency alarm device is provided with a roof buzzer alarm control button, when the passenger presses the roof buzzer control button, the LED light of the roof buzzer alarm will light up, and beep with the horn at the same time, to verify that the passenger emergency alarm device can normally remotely control the roof buzzer alarm;
the driver's mobile phone and the short-distance wireless communication module in the passenger emergency alarm device are connected through short-distance wireless connection,
wherein when the short-range wireless connection signal between the driver's mobile phone and the passenger emergency alarm device is detected to be disconnected, or when the signal value is less than a set value, the horn of the driver's mobile phone and the horn of the passenger's emergency alarm device both buzzed to warn;
the driver's mobile phone uses the GPS chip of the passenger emergency alarm device to find the location of the passenger emergency alarm device;
the driver emergency alarm device includes a remote control part of a roof buzzer alarm and a horn part;
the remote control part of the roof buzzer alarm of the passenger or driver includes a remote control circuit of the roof buzzer alarm, a battery, and a casing, and is equipped with an emergency alarm button for the passenger or driver;
the roof buzzer alarm is set on the roof of the car, the roof buzzer alarm includes circuits, horns, displays or LED lights, headlights and lampshades;
wherein when the passenger or driver presses the emergency alarm button, the horn of the car roof buzzer buzzes to alarm, the display or LED light shows the text message of the alarm, and the headlight flashing display;
wherein when the passenger presses the emergency alarm button, it is equivalent to presses the car door unlock button at the same time, then the car door unlock;
from the time of the passenger gets on the car and confirms the order in the taxi app on the mobile phone, to the time of the passenger end the order in the taxi app after the passenger arrives at the destination and get off the car,
if the detection device of the seat belt lock state detects that the driver has pressed the seat belt lock switch, that is, the driver tries to unfasten the seat belt while the passenger is still in the car,
the safety protection system immediately uses one or more horn, horn in the detection device of the seat belt lock state, horn in the driver's mobile phone, horn in the passenger's mobile phone to sound to alarm at the same time,
the passenger immediately use the car door remote key of the passenger emergency alarm device to open the door, and escape;
or if the detection device of the seat belt lock state detects that the driver has pressed the seat belt lock switch, that is, the driver tries to unfasten the seat belt while the passenger is still in the car, the safety protection system automatic opens the car door;
at the same time, the safety protection system triggers the roof buzzer to buzz through the horn; “Alarm” text is displayed on the display or LED light, the headlight flashes to show to the surrounding traffic police, police, and passers-by;
at the same time, the security protection system immediately turns on the camera and microphone of the driver's mobile phone, and call the emergency handling department of the operating company of the taxi service in the safety protection system, conduct video inspections for the scene, upload the video to the security protection system and storage, when necessary, the video is directly connect to the police;
the safety protection system for passengers and drivers includes a ‘Driver Locking Device’ installed in a vehicle for carrying passengers,
the ‘Driver Locking Device’ locks and fixes the driver on the driver's seat,
the ‘Driver Locking Device’ includes fixed parts, bondage belt, and smart locks;
or, from the time of the passenger gets on the car and confirms the order in the taxi app on the mobile phone, to the time of the passenger end of the order in the taxi app after the passenger arrives at the destination and gets off the car,
if the detection device of the seat belt lock state detects that the driver has pressed the seat belt lock switch, that is, the driver tries to unfasten the seat belt while the passenger is still in the car,
the safety protection system immediately activates the smart lock of the driver locking device to lock the driver in the driver's seat for a set time;
or activate the driver smart lock and the passenger smart lock at the same time, lock the driver in the driver's seat for a set time, and lock the passenger in the passenger seat for a set time;
or when the passenger presses the emergency alarm button, the driver will be locked in the driver's seat for a set time,
or when the driver presses the emergency alarm button, the passenger will be locked in the passenger seat for a set time.

2: The safety protection system for passengers and drivers according to claim 1, wherein the said driver locking device, said mobile phones of passenger and driver, said car seat belt lock state detection device of passenger and driver, said emergency alarm device of passenger and driver, said roof buzzer, and said server of operating company connect together through the mobile Internet or the Internet network;
the fixing component fixes the driver locking device on the driver's seat, or fixed on the top of the car, or fixed on the car chassis, or fixed on the solid parts of the car, or the fixed place is a combination of the above several places;
the binding component includes at least one binding strap, the binding position of the strap is from the driver's shoulder to the driver's waist, or around the driver's waist, chest, or legs, or a combination of the above;
the binding belt is a traditional driver's seat belt material, or cut-resistant material, further, the anti-cutting material is metal, alloy, fiber, glass fiber, or a combination of the above;
the smart lock includes a motherboard, a CPU chip, a memory chip, a mobile communication chip, a GPS chip, a battery, a control component, sensors, a lock core, a bolt, a lock catch, an indicator light, a microphone, a speaker, and a housing;
the strapping belt and the traditional driver's seat belt are separate and independent; or the same, the seat belt is the strap;
there are two ways for passengers to lock and unlock the driver, one way is for passengers to use the taxi application in their mobile phones to directly send instructions of lock and unlock to the driver locking device;
another way is for passengers to send a request to lock or unlock the driver to the cloud software system on the taxi operating company's server;
the cloud software system of the taxi-hailing company sends a lock or unlock instructions to the smart lock of the driver locking device, remotely control the lock and unlock of the driver locking device through the mobile Internet.

3: The safety protection system for passengers and drivers according to claim 1, further comprising isolation protection device for driver and passenger, the isolation protection device for the driver and the passenger is a detachable structure;
the driver and passenger isolation protection device is an “L” shape to isolate the driver separately, and all other passengers share a space,
or is the “cross” shape to isolate the interior of the car into four separate spaces, the driver and each passenger are in a separate isolated space;
the top of the driver and passenger isolation protection device is fixed to the top of the vehicle, the bottom is fixed on the vehicle chassis or seat, the left and right sides are fixed to the frame, the front and back are fixed on the dashboard and the rear seat of the car seat;
the material of the driver and passenger isolation protection device is metal, alloy, glass, bulletproof glass, glass fiber, or a combination of the above;
wherein when the ride-hailing company allocates passenger orders, only vehicles equipped with a cross-shaped driver and passenger isolation protection device will allocate the carpool order to its driver,
vehicles that are not equipped with a “cross”-shaped driver and passenger isolation protection device are not allowed to accept carpool orders, and are not allowed to carry passengers who do not know each other at the same time.

4: The safety protection system for passengers and drivers according to claim 1, wherein from order submission to order confirmation, the following methods and steps are included:
(a) the passengers submit order information to the ride-hailing company, the order information includes the departure location, that is, the driver's pick-up point, departure time, destination point, number of passengers, gender and age of each passenger, and whether to accept a ride-sharing,
the taxi-hailing company automatically records the time when the user submits the order, every time a passenger submits an order, the ride-hailing company verifies the passenger's information, passengers take photos and keep them, or perform facial recognition verification on passengers,
if the passenger chooses not to accept shared rides for this trip, once a driver takes the order, The taxi-hailing company temporarily stops the driver's order-taking function until the driver completes this order;
(b) the ride-hailing company analyzes passenger orders, based on the summary of all order information submitted by all passengers at each time, and the summary of all driver and vehicle information waiting for ordersat each time, two big data information, plus the order allocation algorithm, real-time Make the allocation of each order;
(c) the taxi-hailing company broadcast orders to different drivers, after analyzing the order information submitted by the passengers, base on the information of whether the passengers are single women, pregnant women, the elderly, children, infants, people with mobility impairments, people who have drunk, and whether they accept carpool;
“Important passengers” include single women, pregnant women, the elderly, children, babies, people with limited mobility, and people who have drunk alcohol, if the passenger is an “Important passenger”, Ride-hailing companies automatically mark such orders as “Important passenger orders”, and give a higher level of security protection;
passengers who are not belong to “Important passengers” are “Non-Important passengers”, ride-hailing companies automatically mark such orders as “Non-Important passenger orders”;
the ride-hailing company divides all drivers and vehicles into two categories, drivers and vehicles of the first category can only pick up “Non-Important passenger orders”; another category of drivers and vehicles can pick up all types of passengers, both “Non-Important passengers orders“and” Important passengers orders” can be picked up;
if the passenger is an “Important passengers”, the ride-hailing company will only broadcast this order to specific drivers and vehicles that meet specific requirements; drivers and vehicles that meet specific requirements include: vehicles equipped with seat belt lock state detection devices, emergency alarm devices, roof buzzer alarms, driver lock devices, and isolation protection devices for the driver and passengers;
if the passenger is an “Non-Important passenger”, the ride-hailing company broadcasts this order to all drivers and vehicles;
(d) taxi operating companies divide the geographic area of the earth into different geographic security levels according to population density, degree of safety, public security situation, and the time required for police to arrive;
different types of drivers and vehicles can only accept orders with different geographic security levels, geographical security level includes “safe area” and “non-safe area”;
the ride-hailing company only allocates orders in the “safe area” to female drivers;
if the passenger's departure point, destination point, or itinerary is outside the “safe area”, regardless of whether the passenger who submitted the order is an “Important passengers”, the ride-hailing company only broadcasts the order to male drivers of vehicles equipped with seat belt lock state detection devices, emergency alarm devices, roof buzzer alarms, driver lock devices, and isolation protection devices for drivers and passengers;
only for orders which all the itineraries are within the “safe area”, the ride-hailing company will broadcast the order to all drivers;
only vehicles equipped with driver locking devices and driver and passenger isolation protection devices can accept “high-risk orders”;
the time range of the order itinerary is divided into “safe time” and “non-safe time”, the system broadcast range of “safe time” and “non-safe time” orders, as well as the require conditions of the vehicles and drivers, are equivalent to the “safe area” and “non-safe area” orders;
(e) if the passenger is both an “Important passenger” and the itinerary is out of the “safe area”, or the time is “non-safe time”, the ride-hailing company will mark the order as a “high-risk order” and provide the highest level of safety protection; the highest level of security protection includes full video surveillance, dedicated customer service, direct police video connection, and dedicated escort;
(f) the driver who received the broadcast of the passenger order and is willing to accept this order, the driver clicks the “Get Order” button in the taxi application on his mobile phone, or “Accept” button; the taxi-hailing company will feed back the information of all drivers who have clicked the “Get Order” button to the passengers who submitted the order;
passengers will receive feedback information of all drivers who accept the order; the driver's feedback information includes: the driver's real name, female drivers can choose to display their nicknames, real avatar of the driver, female drivers can choose to display a virtual avatar, driver's age, female driver does not show age, driver height and weight (female driver does not show), exterior photo of the vehicle, whether the vehicle is equipped with a driver locking device, whether the vehicle is equipped with isolation and protection devices for the driver and passengers, vehicle model, vehicle license plate number, vehicle age, whether the driver has passed the background check, whether the driver holds a qualification certificate, whether the vehicle meets the requirements of relevant departments, the average of all passenger ratings, number of complaints from passengers, quotation for this order of the driver;
(g) wherein when the passenger selects the driver and vehicle for this order, the information of selected driver and vehicle are sent to the taxi-hailing company,
the ride-hailing company confirms the order and authenticates the driver selected by the passenger;
identity verification includes face recognition, or fingerprint recognition, or iris recognition, or voice recognition, or a combination of the above several types of identity verification;
at the same time, the taxi-hailing company informed other drivers who accept for this order that they did not succeed in get this order;
(h) the driver who passes the identity verification departs to the pick-up point, same as the departure place submitted by the passenger in this order.

5: The safety protection system for passengers and drivers according to claim 1, wherein the following methods and procedures are included from order confirmation to passenger boarding:
(a) after receiving the order, the driver arrives at the pick-up location, rolls down the window, in the taxi-hailing application provided to the driver which installed in the driver mobile phone, click “Arrive at the pick-up location” to notify passengers and ride-hailing companies;
wherein when the driver arrives at the pick-up location and finds that the gender and number of passengers are inconsistent with the gender and number of passengers in the submitted order information, the driver can choose to cancel the order immediately;
(b) Provided to passengers, the terminal taxi application installed in the passenger mobile phone, after receiving the feedback from the driver that “has arrived at the pick-up location”, display a prompt interface that reminds passengers to check vehicle information,
only when the passenger clicks “confirm” or “unanimous” in the prompt interface of this vehicle information verification, the order enter the next step,
otherwise, the order will be invalidated, and the driver account will be immediately suspended waiting for investigation;
the prompt interface of the terminal taxi application that reminds passengers to check vehicle information includes: show the exterior photos of the vehicle, whether the vehicle is equipped with a driver locking device, whether the vehicle is equipped with isolation protection devices for the driver and passengers, the model of the vehicle, the license plate number of the vehicle;
(c) after the vehicle information is checked and confirmed by the passengers, the terminal taxi application installed in the passenger mobile phone display a prompt interface that reminds passengers to check driver information,
only when the passenger clicks “confirm” or “unanimous” in the prompt interface of this driver information verification, the order enter the next step,
otherwise, the order will be invalidated, and the driver account will be immediately suspended waiting for investigation;
the prompt interface of the terminal taxi application that reminds passengers to check driver information includes: display a clear face photo of the driver, as well as a full-body photo of the driver, the height and weight of the driver, and the age of the driver;
the female driver does not display the above driver information;
the driver full body photo is provided at one time, or before the driver work every day, take today's photos and upload them to the taxi operating company;
(d) the ride-hailing companies divide orders into two categories, bases on the information of the driver's gender, age, height and weight in this order, bases on the information of the number of passengers, bases on the gender and age of each passenger, bases on the information of the departure place, departure time, destination point of the order, bases on the information of whether the order is allow other passengers to ride together;
one type is the order that needs to lock the vehicle driver, and the other type is the order that does not need to lock the vehicle driver;
the types of orders that do not need to lock the driver include: the driver is female, regardless of whether the passenger is male or female; when the driver is male and the passengers are all male;
the types of orders that need to lock the driver include: the driver is a male and the passenger is a female; or the driver is male and all passengers are female;
wherein when the ride-hailing company categorizes this order as an order that does not require the driver to be locked, after the passenger has verified that the vehicle information and driver information are correct, the terminal taxi application in the passenger's mobile phone sends a prompt interface for getting on the bus to the passenger; after the passengers get on the bus, the taxi-hailing company will send the route navigation map of this order to the terminal taxi-hailing application in the driver's mobile phone; this order formally takes effect and enters driving;
wherein when the vehicle of this order is equipped with a seat belt lock state detection device, an emergency alarm device, and a roof buzzer alarm, the further steps are as follows:
(e) the driver passed the passenger emergency alarm device to the passenger standing outside the car through the car window;
(f) passengers press the roof buzzer test button to test whether the remote control function of the top buzzer is normal;
(g) the passenger presses the car door lock remote button on the passenger emergency alarm device to close the door;
(h) the passenger presses the car door unlock remote button on the passenger emergency alarm device to open the car door;
(i) the passenger opens the door, enters the vehicle, clicks the start button, and the operating company sends the driver a navigation route;
When the vehicle of this order is equipped with a vehicle driver locking device, the further steps are as follows:
(j) the cloud software system of the ride-hailing company remotely sends a lock command to the driver lock device on the passenger vehicle after receiving the request from the passenger to lock the driver;
(k) after receiving the lock command from the cloud software system of the taxi operating company, the driver's locking device locks the driver in the driver's seat;
(l) the driver's locking device sends feedback information that the driver has been locked in the driver's seat to passengers and the ride-hailing company;
the driver lock device sends feedback that the driver has been locked to the cloud software system of the ride-hailing company through the mobile communication chip on the smart lock;
the smart lock on the driver's locking device is equipped with an indicator light and a speaker;
wherein when the driver's locking device locks the driver, the loudspeaker emits a clear sound for the passengers to hear, and the indicator light is on for the passengers to see;
(m) after the cloud software system of the taxi-hailing company receives the feedback that the driver's locking device has locked the driver in the driver's seat, the taxi-hailing company sends the terminal taxi-hailing application in the passenger's mobile phone a prompt interface that can enter the vehicle;
and remind passengers on the prompt interface to verify the sound feedback of the speaker of the smart lock on the driver's locking device and the light feedback of the indicator light on the smart lock;
(n) the passenger opens the door, enters the vehicle, clicks the start button, and the operating company sends the driver a navigation route.

6: The safety protection system for passengers and drivers according to claim 1, wherein from the passenger arrival at the destination point to the completion of the order, the following methods and steps are included:
(a) after the passenger arrives at the destination point, the passenger first pays the cost of the order to the taxi operating company in the terminal taxi application in the mobile phone;
(b) the ride-hailing company sends feedback information to the driver after receiving the payment from the passenger;
(c) passengers exit the taxi, at this time, the driver has received the notification message from the taxi-hailing company that the passengers have paid, and the driver must not interfere with the passengers exiting the taxi;
if the vehicle of this order does not equipped with a seat belt lock state detection device, an emergency alarm device, a roof buzzer alarm, and a driver lock device, the further steps are as follows:
(d) passengers evaluate the order and the driver;
(e) after the set time, the taxi operating company will pay the driver the cost of this order;
if the vehicle of this order does equipped with a seat belt lock state detection device, an emergency alarm device, and a roof buzzer alarm, the further steps are as follows:
(f) after the passengers get off the bus, return the passenger emergency alarm device to the driver through the window;
(g) passengers evaluate the order and the driver;
(h) after the set time, the taxi operating company will pay the driver the cost of this order;
if the vehicle of this order is equipped with a driver locking device, the further steps are as follows:
(i) after the passenger exists the taxi and walks to a safe position, send a request to unlock the driver's locking device to the taxi operating company;
if the passenger forgets to send a request to unlock the driver to the taxi operating company after exiting the taxi, the taxi operating company will send an unlock driver prompt interface to the passenger after the set time after the passenger has paid;
(j) when the ride-hailing company receives the passenger's request to unlock the driver, the ride-hailing company remotely sends an unlock command to the driver's locking device on the vehicle;
(k) when the driver locking device on the vehicle receives the unlocking command remotely sent by the taxi operating company, the smart lock of the driver locking device is unlocked;
(l) passengers evaluate the order and the driver;
(m) after the set time, the taxi operating company will pay the driver the cost of this order.

7: The safety protection system for passengers and drivers according to claim 1, wherein the terminal taxi-hailing application provided for passengers to use installed in the passenger's mobile phone, including the passenger silent safety confirmation function;
the passenger silent safety confirmation function comprises:
the passenger setting a security code,
when the passengers are in the vehicle, every set time, a confirmation interface will pop up to confirm the safety of the passengers,
passengers enter the set password to unlock the security confirmation interface,
the silent security confirmation function can be confirmed by the user's face recognition in addition to the user input of the password;
once the passenger's feedback on the safety confirmation interface exceeds the set time, the alarm system will be triggered immediately, the passenger does not need to manually press a button to alarm;
the triggered alarm system is one or more simultaneous alarms of the driver's mobile phone alarm, the passenger's mobile phone alarm, the roof alarm, the alarm platform of the taxi service operating company, and the police alarm platform.

8: The safety protection system for passengers and drivers according to claim 1, wherein prevent strike up a conversation and verbal sexual harassment between the driver and the passenger,
after the passenger boards the taxi, the terminal taxi application in the mobile phone of the driver and the passenger will automatically start sound recording the whole journey;
or in order to protect the privacy of passengers, only the driver's mobile phone is recorded during the whole journey, and the passenger's mobile phone is not recorded;
if the driver strikes up a conversation or sexually harassed the passenger, the passenger can report it in the terminal taxi application,
different types of strike-ups or verbal sexual harassment correspond to different levels of punish for drivers, including fines, account suspension, account closure, and transfer to the police;
as long as the passenger reports, the taxi-hailing company will call out the sound recording for verification,
once it is verified that the passenger's report is true, the driver will be punished immediately.

9: The safety protection system for passengers and drivers according to claim 1, wherein when the taxi-hailing company broadcasts the passenger's order form to the driver, it conceals the passenger's username, gender, and age;
assign a fixed or random string in a fixed format to each passenger's order;
the format of a random fixed-format string is: Year, month, day and time-city-serial number-whether it is a safe area-whether it is a safe time-whether passenger is a key passenger;
‘whether passenger is a key passenger’ is hided when shown to the driver;
the terminal taxi application installed in the mobile phones of passengers and drivers is provided to passengers and drivers, including the functions of text chat and voice call between passengers and drivers,
during the text chat and voice call between the passenger and the driver, the driver displays the real profile picture of the driver, the user name is the real name of the driver, and the license plate number of the vehicle,
passengers do not display avatars, and the user name is a fixed-format string randomly assigned each time.

10: The safety protection system for passengers and drivers according to claim 1, wherein the terminal taxi application program installed in the mobile phone of the passenger and the driver provided for the passenger and the driver includes a reminder interface and a warning interface for prompting the safety of the passenger and the driver;
the reminder interface includes reminding whether there are passengers with limited mobility, whether there are passengers who have drunk alcohol;
the reminder interface for reminding passengers whether to drink alcohol, including a test interface for testing passengers' sobriety level;
the test interface includes logical cognition test questions, response sensitivity test questions, visual clarity test questions, hearing clarity test questions, and passenger video recording;
only passengers who have passed the passenger sobriety test interface are allowed to submit orders;
passengers who fail the test are reminded to contact emergency contacts to pick him up;
the taxi operating company immediately add passengers who fail the passenger sobriety test interface to the high-risk list for key monitoring;
the taxi operating company display the test interface for testing the passenger's sobriety according to the time when the passenger submits the order; as long as it is later than the time set by the system, no matter whether the passenger drinks or not, the test interface for testing the passenger's sobriety will be displayed;
the terminal taxi-hailing application installed in the driver's mobile phone provided to the driver, including a test to detect the driver's fatigue, and a test to detect the driver's sobriety level;
the test of driver's fatigue and sobriety includes video connection check, including the driver's total driving time and total mileage in one day, including the number of consecutive order days, including sobriety test questions;
if the taxi operating company detects that a single woman submits an order later than a certain system set time, the order will be listed as a high-risk order, and the whole process will be monitored by video;
the terminal taxi application includes a reminder interface to remind passengers of the remaining battery power of the mobile phone;
the taxi operating company calculates the approximate time required for the entire trip based on the departure and destination points submitted by the user;
the taxi operating company reads the remaining battery information of the passenger's mobile phone through the terminal taxi application, and calculates whether the remaining battery of the passenger's mobile phone can support the time required for the entire trip;
if it cannot be supported, remind the passenger to bring a mobile phone charging device, or remind the passenger to cancel the order and change the ride time;
for the order type that needs to lock the driver, before the driver submits the order, the taxi operating company will detect the power of the smart lock of the driver's locking device of the driver's vehicle;
if the power of the smart lock is insufficient, suspend order that need to locked the driver, and remind the driver to charge the smart lock
until the power is fully charged, the driver are allowed to take orders that need to locked the driver.

11: The safety protection system for passengers and drivers according to claim 1, wherein contains multiple locking devices,
one is for passengers to lock and unlock the driver;
another one or more for the driver to lock and unlock a passenger, or multiple passengers;
in the case of multiple locking devices, the passenger must lock the driver before the driver lock the passenger; the driver must unlocks the passenger before the passenger unlock the driver;
the passenger presses the passenger emergency unlock button (passenger emergency alarm button) to unlock the “passenger locking device”;
the passenger's emergency unlock button is also the car's door-opening remote control button;
when the passenger presses the passenger emergency unlock button, the rear door of the car opens, and the smart lock on the passenger opens;
at the same time, the roof buzzer on the roof of the vehicle sends out a buzzer alarm signal;
when the passenger or driver presses the emergency unlock button (panic alarm button), the ride-hailing company will conduct video verification of the driver and passenger in real time.

12: The safety protection system for passengers and drivers according to claim 1, wherein ride-hailing companies provide special night service vehicles, which are owned by the ride-hailing companies themselves or rented by themselves;
the drivers recruited and reviewed by the taxi operating company are specially work for the orders of single women, pregnant women, children and other key passengers at night;
the dedicated driver is a woman, and each person wears a camera device on the chest, similar to a Law Enforcement Recorder, and the whole process is recorded;
night service vehicles are equipped with isolation protection devices for drivers and passengers, and are equipped with multiple cameras to record the interior of the vehicle throughout the process;
ride-hailing companies make loans to drivers to purchase and install driver lock devices, and driver-passenger isolation protection devices;
the principal and interest of the loan, which the driver repays through the income of each subsequent order;
the specific repayment method is that all the income of the driver for each order is used to repay until the principal and interest are fully paid; or a percentage of the income of each order that the driver receives is used to repay until the principal and interest are fully repaid.
